(19) United States
(12) Patent Application Publication
(10) Pub. No.: US 2025/0094418 A1
(43) Pub. Date: Mar. 20, 2025

(54) DYNAMIC PIVOT IMPLEMENTATION USING OBJECT AGGREGATION

(71) Applicant: Snowflake Inc., Bozeman, MT (US)

(72) Inventors: Srilakshmi Chintala, Seattle, WA (US); Jianzhun Du, Kirkland, WA (US); Naresh Kumar, Santa Clara, CA (US); Jaeyun Noh, Sunnyvale, CA (US); Srinath Shankar, Belmont, CA (US); Leonhard Franz Spiegelberg, San Francisco, CA (US); Eric Shawn Vandenberg, Saratoga, CA (US); Jiaqi Yan, Menlo Park, CA (US); Andong Zhan, San Mateo, CA (US); Yun Zou, Sunnyvale, CA (US)

(21) Appl. No.: 18/525,811

(22) Filed: Nov. 30, 2023

Related U.S. Application Data
(60) Provisional application No. 63/583,532, filed on Sep. 18, 2023.

(51) Int. Cl. G06F 16/2453

(52) U.S. Cl. CPC G06F 16/24534

(57) ABSTRACT

Examples provide a method for performing dynamic pivot queries employing PANDA-compatible semantics inside a cloud data platform workload. A SQL engine receives a pivot query specifying a pivot column for dynamically determining pivot values in a dynamic pivot operation. The SQL engine identifies, in the pivot query, a keyword or a subquery indicating dynamic determination of the pivot values. Based on identifying the keyword or the subquery indicating the dynamic determination of the pivot values, the SQL engine determines distinct pivot values for the pivot column by evaluating the keyword or executing the subquery. The evaluating of the keyword includes issuing a query to a data store to obtain the distinct pivot values for the pivot column. The SQL engine performs the dynamic pivot operation using the distinct pivot values for the pivot column.

### CROSS-REFERENCE TO RELATED APPLICATIONS

The present application claims benefit of earlier filing date and right of priority to U.S. Provisional Patent Application Ser. No. 63/583,532, filed on Sep. 18, 2023, entitled, “DYNAMIC PIVOT IMPLEMENTATION USING OBJECT AGGREGATION,” all of the contents of which are hereby incorporated by reference herein in its entirety.

### TECHNICAL FIELD

The present disclosure generally relates to special-purpose machines that manage data platforms and databases and, more specifically, to incorporating a developer framework and programming environment for structured query language (SQL) dynamic pivot into such data platforms and databases.

### BACKGROUND

Network-based database systems can be provided through a cloud data platform, which allows organizations, customers, and users to store, manage, and retrieve data from the cloud. Cloud data platforms are widely used for data storage and data access in computing and communication contexts. With respect to architecture, a cloud data platform could be an on-premises data platform, a network-based data platform (e.g., a cloud-based data platform), another type of architecture, or some combination thereof. With respect to type of data processing, a cloud data platform could implement online analytical processing (OLAP), online transactional processing (OLTP), a combination of the two, another type of data processing, or some combination thereof. Moreover, a cloud data platform could be or include a relational database management system (RDBMS) or one or more other types of database management systems.

In an implementation of a cloud data platform, a given database (e.g., a database maintained for a customer account) can reside as an object (e.g., within a customer account) that can also include one or more other objects (e.g., users, roles, privileges, and/or the like). Furthermore, a given object, such as a database, can itself contain one or more objects such as schemas, tables, materialized views, and/or the like. A given table can be organized as a collection of records (e.g., rows) that each include a plurality of attributes (e.g., columns). In some implementations, database data can be physically stored across multiple storage units, which may be referred to as files, blocks, partitions, micro-partitions, and/or by one or more other names. In many cases, a database on a cloud data platform serves as a backend for one or more applications that are executing on one or more application servers.

Data engineers are focused primarily on building and maintaining data pipelines that transport data through different steps and put it into a usable state. The data engineering process encompasses the overall effort required to create data pipelines that automate the transfer of data from place to place and transform that data into a specific format for a certain type of analysis. In that sense, data engineering is an ongoing practice that involves collecting, preparing, transforming, and delivering data. A data pipeline helps automate these tasks so they can be reliably repeated.

### BRIEF DESCRIPTION OF THE SEVERAL VIEWS OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. The drawings illustrate generally, by way of example, but not by way of limitation, various embodiments discussed in the present document. Various ones of the appended drawings merely illustrate example embodiments of the present disclosure and should not be considered as limiting its scope.

FIG. 1 illustrates an example computing environment in which a cloud data platform, in communication with a cloud storage platform, can implement a dynamic pivot, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a computing environment conceptually illustrating an example software architecture executing a user defined function (UDF) by a process running on a given execution node of the execution platform, according to some example embodiments.

FIG. 5 illustrates examples of a developer framework and programming environment DataFrame API used by a user to execute a dynamic pivot on a pivot table on larger cloud data platform tables, according to some example embodiments.

FIG. 6A illustrates a dataset in which a dynamic pivot functionality is used to create a DataFrame, according to some example embodiments.

FIG. 6B illustrates a dataset in which a dynamic pivot operation is used to create a DataFrame, according to some example embodiments.

FIG. 7 illustrates PANDAS-compatible semantics employed inside a cloud data platform, according to some example embodiments.

FIG. 8A illustrates SQL queries including dynamic pivot subqueries, according to some example embodiments.

FIG. 8B illustrates SQL query with explicit management and DataFrame, according to some example embodiments.

FIG. 9 illustrates SQL queries including dynamic pivot subqueries, according to some example embodiments.

FIG. 10 illustrates SQL queries including dynamic pivot subqueries including dataset values operated on by the respective dynamic pivot subqueries for only some None values, according to some example embodiments.

FIG. 11 illustrates a dynamic pivot ordering mechanism, according to some example embodiments.

FIG. 12 illustrates how PANDAS-compatible semantics are employed to perform dynamic pivot ordering, according to some example embodiments.

FIG. 13 illustrates an example flow diagram of a method for performing dynamic pivot operations, according to some example embodiments.

FIG. 14 illustrates an example flow diagram of a method for performing dynamic pivot operations including additional pivot queries, according to some example embodiments.

FIG. 15 illustrates an example diagrammatic representation of a machine in the form of a computer system within which a set of instructions may be executed for causing the machine to perform any one or more of the methodologies discussed herein, according to some example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. For the purposes of this description, the phrase “cloud data platform” may be referred to as and used interchangeably with the phrases “a network-based database system,” “a database system,” or merely “a platform.”

Disclosed herein are various examples of systems and methods for providing a developer framework and programming environment that integrates application development capabilities directly into the cloud data warehouse platform. The developer framework and programming environment enables developers to author scripts and applications utilizing common programming languages that can interface with cloud data warehouse tables, execute queries, invoke functions, and similar operations. The cloud data platform including the developer framework and programming environment includes syntax extension(s) that extend the current pivot to support dynamic pivot with fill-up value. Where dynamic pivot provides a primitive that allows computation of a pivot operation without knowing upfront which values to pivot on (e.g., static pivot), but rather perform this dynamically on the input data. For example, dynamic pivot according to examples of the present disclosure can be expressed as:

```
SELECT...
FROM...
  PIVOT [INTO VARIANT] (<aggregate_function>)
  ( <pivot_column> )
    FOR <value_column> IN ( <pivot_value_1> [, <pivot_value_2>
...] | ANY | <subquery>) [DEFAULT ON NULL (<value>) ] )
```

Example embodiments include extensions in this syntax, where the extensions can help reduce the statements and/or steps that need to be performed on the client-side for common pivot use cases. A first syntax extension allows ANY keyword in the IN clause, when ANY key word is used, pivot is done on all distinct values of the pivot column, and NULL is also treated as a pivot value if the values in the pivot column contains NULL. A second syntax extension allows using a subquery in the IN clause. The type of subquery allowed here are uncorrelated subqueries that return a single column, and pivoting is performed on all distinct values returned from that subquery. A third syntax extension allows for an optional DEFAULT ON NULL clause, once specified, all NULLs in the pivot result will be replaced with the default value configured. The default value accepts any scalar expression that does not depend on the pivot and aggregation column. A fourth syntax extension allows for an optional INTO VARIANT clause that generates variant-type output for the query. With variant-type output, the values of the pivot column are evaluated at execution time and returned as a variant. During execution, the aggregate function is applied to each distinct pivot value, and the query returns a single column of variant containing all value and measure pairs. This may not solve issues in the cloud data platform DataFrame pivot where it is needed to know the pivot values ahead of execution, but it helps the other general use cases described throughout.

Existing solutions have attempted this from the client-side, involving rewriting pivot using a single GROUP BY clause and conditional aggregation for each pivot value. For example, a trivial, prior solution was to use two queries; a first query to determine the values to pivot on and a second query is then generated based on the result of the first query. As a result, the pivot values need to be statically provided as part of a pivot query.

In existing platforms, pivot unique values from one column are supported, which causes compilation timeout once the number of pivot values becomes large. Major overhead comes from the complicated case expression introduced per pivot value during SqlObjectNameResolver, which causes high compilation time for many of the later stages including OptimizeQueryPlan, PerformRewrite, etc. Additional existing solutions require filling up of all pivot values. An example of an existing platform includes PANDAS, which is a software library implemented in the Python programming language designed for data manipulation and analysis. In particular, PANDAS provides data structures and operations optimized for working with tabular numerical data and time series data. PANDAS enables importing data from various formats, such as Comma-Separated Values (CSV), JavaScript Object Notation (JSON), Structured Query Language (SQL) databases, and the like. PANDAS supports common data manipulation operations including merging, reshaping, selecting, cleaning, and wrangling of data. A key capability provided by PANDAS is the DataFrame, which introduces comparable tabular data manipulation features as found in the R programming language and in Python. PANDAS is focused on high-level features for working with tabular and time series data rather than just arrays.

A DataFrame is a popular data structure used ubiquitously in data science and analytics applications to represent tabular, spreadsheet-like data. DataFrames organize data into a table with labeled rows and columns that can store a variety of data types. They provide intuitive access methods to manipulate data by row or column labels. DataFrames also include optimized operations for data analysis tasks like filtering, aggregation, visualization, and machine learning. Leading data science libraries implement DataFrame abstractions that are fundamental to flexible, rapid data manipulation. The developer framework as described in examples herein enables direct interoperation between the DataFrame representations in programming languages like Python and the parallel processing engine of the cloud data platform. Binding these data analysis programming models with the cloud data platform's storage and processing capabilities provides a seamless, scalable environment to build advanced analytics.

For example, PANDAS pivot is applied on columns, and uses all of the distinct values of a column, instead of specific values from a column. In order to construct the final pivot query for PANDAS, a SELECT DISTINCT query needs to be issued first to get all distinct values, which increase client-side complexity. Furthermore, the query text becomes really large once the number of pivot values increases, and this decreases the readability of the final query when the explain ( ) function is called at client side. Additionally, restricted functionalities that require tedious client-side work to support PANDAS pivot operation capabilities are required. For example: PANDAS supports extra parameters that allow filling up all NULLs with a specific value.

To address these and other issues, as well as shortcomings of prior implementations, disclosed herein are various examples of systems and methods for handling tens of thousands of pivot values within seconds or minutes for both static and dynamic pivot, and for extending the pivot syntax to provide functionalities for any value in the pivot column and fill value to simplify DataFrame client-side work employing dynamic pivot. Dynamic pivot as described herein allows work in a single query, effectively reducing a 2-pass approach to a 1-pass approach. Examples described herein overcome the current technological challenges by providing the ability to specify pivot values dynamically at query runtime using the ‘ANY’ keyword or a subquery provides more flexibility compared to prior art that requires predefined specification of pivot values. This avoids the need for extra client-server round trips just to determine the pivot values.

Examples of the present disclosure further overcome the performance shortcomings of prior implementations by providing pivot query rewriting and optimizations, particularly the use of object aggregation, to improve performance and scalability over prior pivot implementations that do individual aggregations for each pivot value. The object aggregation technique reduces overhead compared to these prior techniques. Further, the addition of the ORDER BY clause enables customized ordering of output pivot columns; for example, in some examples, by default it can be ordered by the lexicographical order. This provides control over column ordering. The examples described herein include techniques that also improve handling of edge cases, such as empty result sets, mixed data types, nested pivots, and the like over prior pivot implementations. Specific handling of inconsistencies and predefined techniques to address edge cases result in more robust and consistent pivot behavior compared to prior implementations. Overall, the dynamic determination of pivot values, efficient query rewriting using object aggregation, configurable column ordering, and robust edge case handling provide significant improvements over conventional pivot implementations in databases, analytics platforms, or the like.

Examples described herein include technical solutions over prior pivot techniques by providing more efficient dynamic pivot implementation, which scale better than the prior techniques. The innovations of the present disclosure allow the system to handle large volumes of data while maintaining performance through massive parallelism, eliminating redundancy in aggregations, and minimizing query compilation and network overhead. Examples further address shortcomings of prior implementations by being dynamic. For example, dynamic pivot is dynamic in that the pivot values do not need to be specified upfront but rather can be determined at runtime by a subquery. A pivot query is internally written using object aggregation that applies the aggregation on each pivot value without having to explicitly specify the aggregation for the pivot value column. The pivot query is a query written for a pivot table to be visualized based on the query.

A pivot table is a data visualization that summarizes and reorganizes tabular data into a more compact format for analysis. The input data for a pivot table is typically, for example, a table with columns of data. To generate a pivot table visualization, a pivot query needs to be written to transform the input table into the desired layout and aggregations used in the pivot table. For exemplary purposes and without limitation, the pivot query can perform operations like pivoting columns into rows, applying aggregate functions like sums or counts, filtering or grouping the data as needed, or the like. For example, a pivot query can be a Structured Query Language (SQL) or other query that is written specifically to transform an input data table into the formatted result set that will populate the pivot table visualization. The pivot query defines the business logic and transformations required to go from the raw data table to the final pivot table presentation. Once the pivot query is defined, the pivot table can then be automatically visualized based on the result set from executing the pivot query against the input data.

Examples described herein include a dynamic pivot implementation to overcome the major challenge of pivot syntax from a compiler perspective in which it creates an additional number of columns depending on the pivot values listed in the syntax. When the subquery or ‘ANY’ keyword is used in the syntax, the compiler does not know the name of newly added columns and the count of columns. The cloud data platform has to evaluate the given query and/or evaluate the target of the pivot table. To this end, a child task API is used to execute the subquery during a name resolution step for pivot object reference.

Example embodiments provide for improvements over the prior techniques by providing more efficiency and better scalability in terms of pivot values, including, for example, providing dynamic specification of pivot values by introducing subqueries, providing deterministic ordering of pivot output columns, including default value support for null output values, and providing better consistency in handling empty datasets.

Example embodiments of the present disclosure help onboarding the data science workflow by providing a drop-in replacement for the PANDAS plugin and enabling usage of the cloud data platform distributed execution engine. In order to achieve this, the cloud data platform DataFrame supports the same API as PANDAS and translates the PANDAS operations to cloud data platform SQL for execution. Pivot is a commonly used operation for many PANDAS APIs, including DataFrame.pivot, DataFrame.pivot_table, and DataFrame.transpose etc. Using example embodiments of the present disclosure, each of these operations (and more) can be transpiled effectively via a dynamic pivot primitive. Pivot reshapes data with distinct values from pivot columns, where it turns each of the unique values into a new column and aggregates the result on the remaining columns.

With the developer framework and programming environment DataFrame according to examples, the pivot_table and similar PANDAS APIs need to execute efficiently on larger cloud data platform tables to support core data engineering scenarios. The new dynamic pivot implementation improves the underlying performance beyond the existing SQL pivot in two ways. First, the underlying pivot query is rewritten in a way that is more performant to compile and execute compared to the prior implementation by using an object aggregation rather than individually specifying each aggregation. Second, the new pivot is dynamic and can determine the pivot values at runtime, avoiding the extra overhead of a client-server query to determine these values. The dynamic pivot is provided by extending the existing SQL pivot operator syntax, used through the developer framework and programming environment pivot and the developer framework and programming environment DataFrame API. The deeply integrated programming experience of the developer framework and programming environment improves developer productivity when building analytics and data processing workflows leveraging the scale and performance of the cloud data platform.

Examples of dynamic pivot improve pivot performance using the syntax extensions described herein to help reduce the client-side complexity but will not help the compilation time for pivots if they are still rewritten into a case expression for each pivot value. To resolve the compilation time issue, case expressions are eliminated by rewriting the pivot representation to use object aggregation (e.g., OBJECT_AGG). This rewriting happens on a pivot's query block in the parsing of a syntax tree or an abstract syntax tree after name resolution. The rewriting into a case expression for each pivot value applies an aggregation metric on the aggregation column, and GROUP BY the remaining visible columns from the source table including the pivot column. The pivot tables allow summarization of data by applying an aggregation metric when grouping rows and/or columns by one or more categories. Some common aggregation metrics used in pivot tables include, but are not limited to: Sum, which adds up all the values for the given column. Count, which counts the number of rows for each group. Average, which calculates the average (also referred to as mean) value for the given column. Minimum, which finds the smallest value in the given column for each group. Maximum, which finds the largest value in the given column for each group. As an example, in a pivot table that groups sales data by product and pivots on the “Revenue” column, the aggregation metric might be SUM (Revenue), which would total or add up the revenue values for each product group when constructing the pivot table. Selecting the appropriate aggregation metric generates a useful pivot table report that summarizes the data in a meaningful way as rows are grouped together through the pivot operation.

With the result, the rewriting creates (e.g., generates, produces, etc.) an aggregation object with the pivot column as a key and aggregation result column as a value. The keys of aggregation objects are then flattened into columns based on the output columns (e.g., outputColumns). The output columns can be populated with extracted pivot values, generated pivot values, potential pivot values, or the like. For example, the following query is presented: #foo is a table with columns a, b, and c SELECT * FROM foo PIVOT (sum(a) FOR b IN (1, 2, 3)). The below Table 1 shows the new query with the old rewrite and new rewrite rule during a SQL query compiler module (e.g., SqlObject) within the cloud data platform responsible for parsing SQL queries, resolving names, applying optimizations, query rewrites, generating execution plans, or the like. The dynamic pivot innovations integrate to enable the improved performance and flexibility described herein.

TABLE 1

| Old Rewrite with case | New Rewrite with object_agg |
|---|---|
| SELECT * FROM ( | SELECT * FROM [symbol] |
| SELECT c | [symbol] flatten the aggregation obj into |
| sum(case when b [symbol] 1 then | columns |
| [symbol] end) as 1, | SELECT c, OBJ [symbol] 1 [symbol] number, |
| sum(case when b [symbol] 2 then | OBJ [symbol] 2 [symbol] number, OBJ [symbol] 3 [symbol] number |
| [symbol] end) as 2, | FROM ( |
| sum(case when b [symbol] 3 then | SELECT c, OBJECT_AGG(b, [symbol] ) OBJ |
| [symbol] end) as 3 | FROM ( |
| FROM foo, | SELECT c, b, sum(a) [symbol] |
| GROUP BY c) | FROM foo |
| | GROUP BY c, b |
| | [symbol] |
| | GROUP BY c |
| | [symbol] |

[symbol]

indicates data missing or illegible when filed

According to example embodiments employing the new rewrite, the final query complexity actually increases, where the pivot is replaced with three SELECTS instead of one.

In additional embodiments, the system for integrating programming capabilities into a cloud data warehouse platform includes a cloud data warehouse containing database tables storing large volumes of data, a developer framework that provides interfaces enabling querying, manipulating, and operating on the cloud data warehouse tables, a programming environment where developers author scripts and applications using common programming languages that connect to the developer framework, syntax extensions that add capabilities like dynamic pivoting to the developer framework and programming environment, and an optional sandbox environment that provides a secure, isolated environment for running untrusted code scripts and applications. The developer writes code in the programming environment that connects to the developer framework to access the cloud data warehouse, executes queries, functions, and operations against the cloud data warehouse tables, and returns results back to the programming environment code.

Additional example embodiments can be performed in a sandbox environment. In computer security, a sandbox (e.g., sandbox environment) is a security mechanism for separating running programs, usually to prevent system failures or prevent exploitation of software vulnerabilities. A sandbox can be used to execute untested or untrusted packages, programs, functions, or code, possibly from unverified or untrusted third parties, suppliers, users, or websites, without risking harm to the host machine or operating system. A sandbox can provide a tightly controlled set of resources for guest programs to run in, such as storage and memory scratch space. Network access, the ability to inspect the host system or read from input devices can be disallowed or restricted. UDFs typically can run in a sandbox environment.

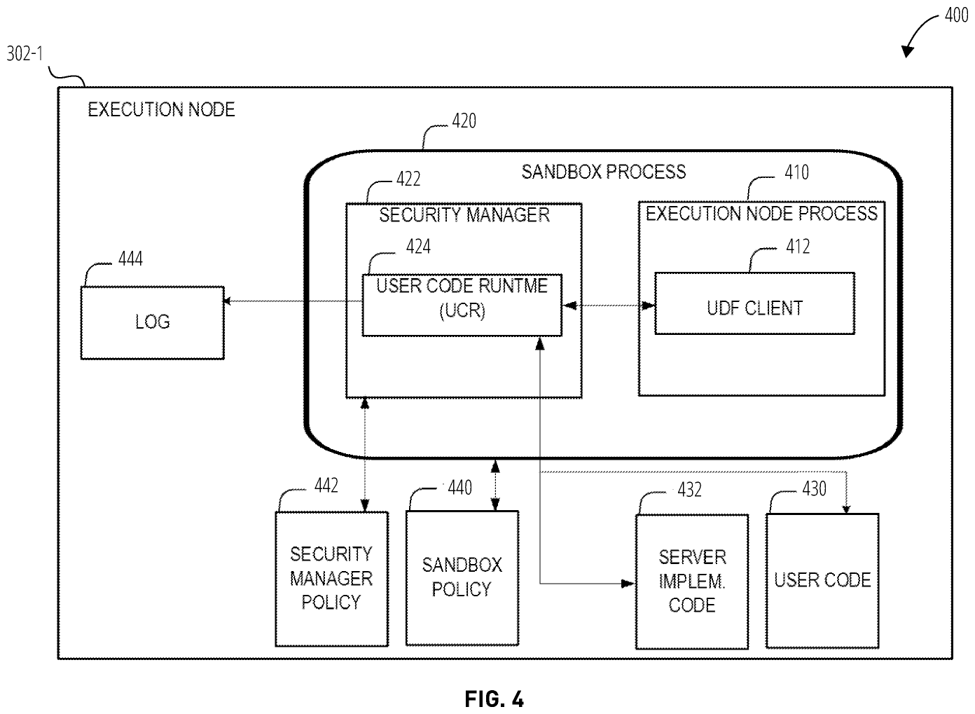

The optional sandbox environment provides important security isolation for untrusted code execution. It restricts access to resources like storage, memory, and network connectivity to contain untrusted code. Policies can enforce permissions, resource limits, auditing, and multi-tenant isolation when running User Defined Functions (UDFs) from different users. The developer framework delivers a unified interface to the cloud data warehouse for languages like Python and Structured Query Language (SQL). It layers common Application Programming Interfaces (APIs) like pivot_table( ) on top of the core cloud computing platform while reusing authorization and Single Sign-On (SSO). This enables invoking advanced functionality like dynamic pivot through an integrated programming experience. For example, pivot values can be specified dynamically using parameters like ‘ANY’ or subqueries. In additional examples, the transpose( ) API and/or custom pivot( ) API can build on this capability. The developer framework query interface allows directly using the SQL extensions for default pivot values, output variants, and more. Together these invocation options highlight the flexible integration of dynamic pivot into the warehouse through the developer framework. Some example embodiments described herein can be run within a sandbox environment, which is described and depicted in more detail in connection with FIG. 4.

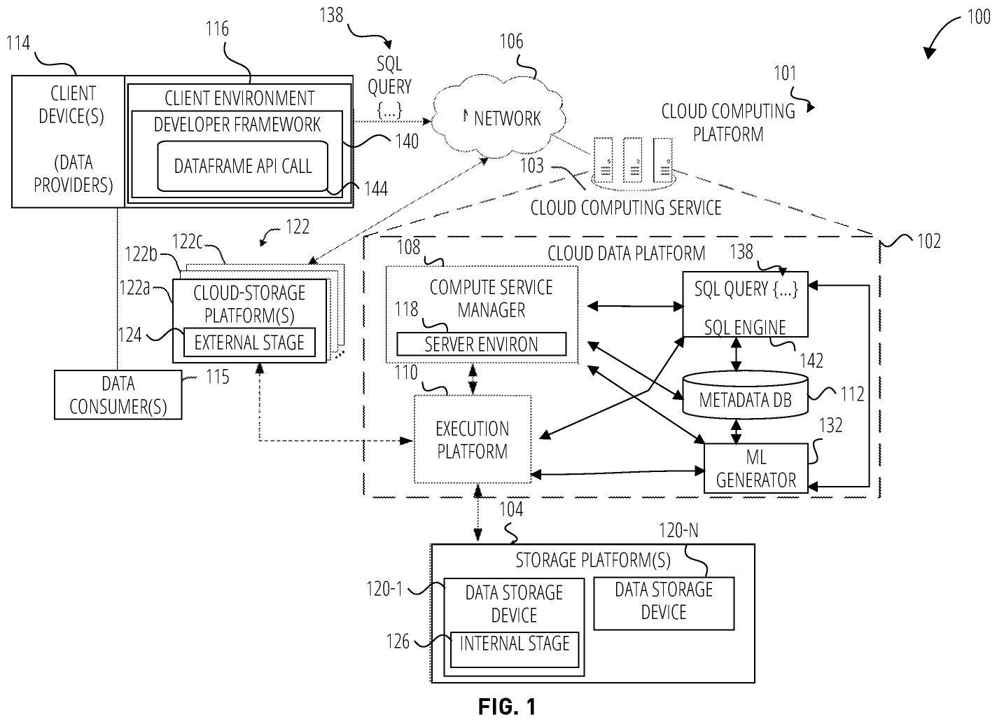

FIG. 1 is an example computing environment 100 illustrating a cloud data platform 102 including a developer framework and programming environment that integrates application development functionality with DataFrame capabilities, in accordance with some embodiments of the present disclosure.

To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of cloud data platform or a cloud data platform. For example, in some aspects, the computing environment 100 may include a cloud computing platform 101 with the cloud data platform 102 and a storage platform 104 (also referred to as a cloud storage platform). The cloud computing platform 101 provides computing resources and storage resources that can be acquired (purchased) or leased and configured to execute applications and store data.

The cloud computing platform 101 may host a cloud computing service 103 that facilitates storage of data on the cloud computing platform 101 (e.g., data management, access, etc.) and analysis functions (e.g., SQL queries, analysis, etc.), as well as other processing capabilities. The cloud computing platform 101 may include a three-tier architecture: data storage (e.g., storage platform 104 and storage platforms 122), an execution platform 110 (e.g., providing query processing), and a compute service manager 108 providing cloud services including services associated with the examples functionalities described herein.

In the present disclosure, a cloud data platform 102 (e.g., database system, distributed database system) can support data storage for one or more different organizations (e.g., customer organizations, which can be individual companies or business entities), where each individual organization can have one or more accounts (e.g., customer accounts) associated with the individual organizations, and each account can have one or more users (e.g., unique usernames or logins with associated authentication information). In an example implementation, a cloud data platform includes one or more databases that are maintained on behalf of a customer account (e.g., accounts of one or more data providers). Data can be shared between a provider account, which owns the data, and a consumer account (e.g., receiver account, data consumer, etc.), which can have access to the data using two-way secure data sharing between private and public clouds according to a relationship establishment procedure (e.g., a handshake) to ensure a trust relationship is established between the provider and the consumer. Users or executing processes that are associated with a given customer account can, via one or more types of clients, be able to cause data to be ingested into the database, and can also be able to manipulate the data, add additional data, remove data, run queries against the data, generate views of the data, and so forth. Moreover, it is often the case that data providers are direct customers of a cloud data platform. As examples, data providers can provide one or more types of data, such as financial data (e.g., stock prices), weather data, pandemic test results, vaccination levels, and/or the like. These data providers, using client device(s) 114, typically have one or more customers of their own that consume the data; these entities are referred to in the present disclosure as “data consumer(s) 115” or simply “consumers.” In some examples, a data consumer might be a trading house that consumes financial data from a data provider.

Additionally, an individual account can have one or more users that are designated as an administrator for the individual account. An individual account of an organization can be associated with a specific cloud platform (e.g., cloud-storage platform, such as such as AMAZON WEB SERVICES™ (AWS™), MICROSOFT® AZURE®, GOOGLE CLOUD PLATFORM™), one or more servers or data centers servicing a specific region (e.g., geographic regions such as North America, South America, Europe, Middles East, Asia, the Pacific, etc.), a specific version of a data platform, or a combination thereof. A user of an individual account can be unique to the account. Additionally, a cloud data platform can use an organization data object to link accounts associated with (e.g., owned by) an organization, which can facilitate management of objects associated with the organization, account management, billing, replication, failover/failback, data sharing within the organization, and the like.

In a typical implementation, a cloud data platform 102 includes one or more databases that are maintained on behalf of a user account. The cloud data platform 102 may include one or more databases that are respectively maintained in association with any number of user accounts (e.g., accounts of one or more data providers or other types of users), as well as one or more databases associated with a system account (e.g., an administrative account) of the cloud data platform 102, one or more other databases used for administrative purposes, and/or one or more other databases that are maintained in association with one or more other organizations and/or for any other purposes. A cloud data platform 102 may also store metadata (e.g., account object metadata) in metadata database(s) 112 in association with the data platform in general and in association with, for example, particular databases and/or particular user accounts as well. Users and/or executing processes that are associated with a given user account may, via one or more types of clients (e.g., customer environment), be able to cause data to be ingested into the database, and may also be able to manipulate the data, add additional data, remove data, run queries against the data, generate views of the data, and so forth.

It is often the case that organizations that are users of a given data platform also maintain data storage (e.g., a data lake) that is external to the data platform (e.g., one or more external storage locations, external stage 124). For example, a company could be a user of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The user's servers and cloud-storage platforms are both examples of what a given user could use as what is referred to herein as an external storage location. The cloud computing platform 101 could also use a cloud storage platform 104 as what is referred to herein as an internal storage (e.g., internal stage 126) location concerning the data platform.

From the perspective of the cloud data platform 102 of the cloud computing platform 101, one or more files that are stored at one or more storage locations are referred to herein as being organized into one or more of what is referred to herein as either “internal stages 126” or “external stages 124.” Internal stages 126 are stages that correspond to data storage at one or more internal storage locations, and internal stages 124 are stages that correspond to data storage at one or more external storage locations. In this regard, external files can be stored in internal stages 124 at one or more external storage locations cloud-storage platforms 122, and internal files can be stored in internal stages 126 at one or more internal storage locations (e.g., cloud storage platform 104), which can include servers managed and controlled by the same organization (e.g., company) that manages and controls the cloud data platform 102, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given user stores at a given external storage location may or may not be stored in an external stage in the external storage location; in some data-platform implementations, it is a user's choice whether to create one or more external stages (e.g., one or more external-stage objects) in the user's data-platform account as an organizational and functional construct for conveniently interacting via the data platform with one or more external files.

As shown, the cloud data platform 102 of the cloud computing platform 101 is in communication with the storage platform 104 and cloud-storage platforms 122 (e.g., AWS®, Microsoft Azure Blob Storage®, or Google Cloud Storage). The cloud data platform 102 is a network-based system used for reporting and analysis of integrated data from one or more disparate sources including one or more storage locations within the storage platform 104. The storage platform 104 comprises a plurality of computing machines and provides on-demand computer system resources such as data storage and computing power to the cloud data platform 102.

The cloud data platform 102 comprises a compute service manager 108, an execution platform 110, and one or more metadata databases 112. The cloud data platform 102 hosts and provides data reporting and analysis services to multiple client accounts.

The compute service manager 108 coordinates and manages operations of the cloud data platform 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device(s) 114. The client device(s) 114 correspond to a user of one of the multiple client accounts (e.g., data provider accounts) supported by the cloud data platform 102. A user may utilize the client device(s) 114 to submit data storage, retrieval, and analysis requests to the compute service manager 108. Client device(s) 114 (also referred to as a user device) may include one or more of a laptop computer, a desktop computer, a mobile phone (e.g., a smartphone), a tablet computer, a cloud-hosted computer, cloud-hosted serverless processes, or other computing processes or devices that may be used to access services provided by the cloud computing platform 101 (e.g., cloud computing service 103) by way of a network 106, such as the Internet or a private network. The developer can write code (e.g., developer framework and programming environment Python code) in a local development environment of the client device(s) 114, a Python worksheet in the query user interface of the cloud data platform, a client application, client environment 116, or the like. For example, a developer (e.g., a data engineer of a data provider using client environment 116 on client device(s) 114) can set up the user's preferred development environment and establish a session to interact with the cloud data platform 102. For example, example embodiments can include a client environment (e.g., client component), such as a cloud data platform Java Database Connectivity (JDBC) or cloud data platform Open Database Connectivity (ODBC) client used to connect to the cloud computing platform 101, such as any of the cloud data platform system, components, facilities, and/or applications.

A client, such as a presentation client, could reside on a client-side computing device on which the client interacts with one or more client-side applications and on which the client makes use of certain client-side-system resources such as network interfaces, user interfaces, memory (e.g., random access memory (RAM)), and/or the like. The client environment 116 can include a developer framework 140 to form a user-friendly abstraction layer over underlying data and uses a DataFrame API call 144 to transmit a query, such as SQL query 138 that includes dynamic pivot functionality, transmitted to the cloud data platform 102 via network 106.

According to example embodiments, the cloud data platform 102 is operatively connected to a developer framework and programming environment (also referred to throughout the disclosure as the “developer framework” or simply, “the framework”) that enables data engineers, data scientists, developers, or other users to build complex data pipelines and processes using common programming languages, such as Python, Scala, Java, or the like. The developer framework 140 allows developers to directly interact with the cloud data platform 102 to run queries, such as SQL query 138, and operations without having to extract and move data out of the platform. The developer framework 140 provides libraries and runtimes to securely execute non-SQL code within the cloud data platform 102. With the developer framework 140, developers can construct DataFrame queries and transformations programmatically in their code via the client environment 116. The developer framework 140 dynamically generates the underlying SQL code to execute against the cloud data platform 102 in a robust and schema-driven manner. The developer framework 140 simplifies building complex pipelines and provides developers direct data access, in some examples, avoiding extract, transform, and load (ETL) steps.

The compute service manager 108, or other component of the cloud data platform 102, provides a developer framework to enable Python (or other programming languages) programming directly against platform data and services. Example embodiments include reading data into platform native DataFrames and PANDAS-compatible DataFrames; leveraging Python data transformations, scripts, and libraries; writing data back to the platform; creating and invoking custom Python user-defined functions and stored procedures; and applying Python machine learning models for predictive analytics. This deeply integrated Python (other programming languages) programming experience allows developers, via client device(s) 114 and developer framework 140, to build complex analytical workflows that leverage both the flexibility of Python and the scale, concurrency, and performance of the cloud data platform 102. The developer framework 140 eliminates extract, transform, and load burdens, enables code re-use and portability, and brings advanced analytics like predictive modeling directly to data residing on the cloud data platform. By bridging Python (or other programming languages) and SQL programming styles, the developer framework 140 boosts developer productivity and advanced analytic capability for the cloud data platform.

The developer framework 140 can include a function invocation provided by a DataFrame library, such as PANDAS or Spark®, which implements operations on the DataFrame for data tasks. Dataframe libraries implement a functional abstraction layer enabling users to manipulate in-memory tabular data structures known as DataFrames. This is provided via an expressive application programming interface (API) of functions and methods tailored for data preparation, transformation, analysis, and visualization tasks. Dataframe APIs allow accessing, filtering, aggregating, pivoting, joining and otherwise operating on DataFrame data using concise and intuitive syntax. The API calls, such as DataFrame API call 144, map to underlying queries, such as SQL query 138, and data processing engines (not shown) in the client environment 116 and/or the server environment 118. According to some examples of the developer framework 140, examples of client APIs for invoking the dynamic pivot capability include, for example: developer framework Python API as df.pivot( ) developer framework Scala API as df.pivot( ) developer framework Java API as DataFrame.pivot( ) cloud data platform SQL as PIVOT syntax, developer framework R API as pivot_table( ).

Examples described herein include implementing a dynamic pivot operator within a distributed data analytics platform, such as a database system. A pivot operator transposes unique values from an input column into new output columns while performing aggregations on other measures. The dynamic pivot avoids predefined specifications of the output columns and instead determines (e.g., obtain, identify) distinct pivot values at runtime based on the input data. This is enabled via syntax extensions allowing the use of subqueries or keywords indicating all distinct values of the pivot column. A database system backend, such as a server environment 118 or a SQL engine 142 operatively interconnected with a compute service manager 108, transforms this into optimized queries using object aggregation, deterministic ordering, or the like to efficiently compute results of the SQL query including the dynamic pivot, in accordance with example embodiments of the present disclosure. Additional client-side logic, such as logic in a developer framework 140, handles multi-pivot scenarios, margins, and other parameters. The dynamic pivot forms a core building block for translating various DataFrame APIs in the application layer into efficient distributed execution. By avoiding rigid specifications and optimizing computations, the dynamic pivot scales to handle data volumes beyond the capabilities of prior rigid implementations.

The application layer APIs and libraries call the dynamic pivot by passing input data and parameters. This gets translated into a SQL query with extended pivot syntax and submitted to the distributed data warehouse. The cloud data platform 102 includes a SQL engine 142 to optimize dynamic pivot implementation according to example embodiments of the present disclosure. While the SQL engine 142 is illustrated within the cloud data platform 102, those skilled in the art will understand that the SQL engine 142 can be otherwise operatively connected to the cloud data platform 102. The SQL engine 142 leverages optimization rules to rewrite the pivot into efficient distributed execution plans using techniques like object aggregation. Intermediate data shuffles across worker nodes are handled by a cluster resource manager (not shown) or other component of the cloud data platform 102. Results are streamed back to populate the client DataFrame. Additional transformations like margins may be applied before returning the final DataFrame via the developer framework 140, client environment 116, DataFrame API call 144, or other components of the client device(s) 114. This integration enables advanced analytic workflows with data reshaping operations to leverage the dynamic pivot capability for scalable distributed execution.

According to additional examples, during distributed execution, shuffle operations and data exchanges work as follows: the initial group by aggregations are computed locally on each worker's data partitions, this intermediate aggregated data is shuffled across nodes to compute the object aggregation, and the object aggregation output is partitioned again and shuffled to materialize the final pivot columns. Data partitioning schemes optimize shuffle sizes between stages to minimize data exchange and a resource manager, such as a cluster resource manager, handles routing of all intermediate shuffle data exchanges between worker nodes. Examples of shuffle operations exchange intermediate results between stages of distributed aggregation and materialization to efficiently compute the pivot across massive datasets. Additional examples of shuffle operations can include identifying a logical plan and converting the logical plan into an optimized logical plan. The optimized logical plan can be converted into a physical distributed execution plan for use with shuffle stages for intermediate data exchange. The physical distributed execution plan can be dispatched (e.g., forwarded, transmitted, etc.) to the worker nodes for parallel distributed execution across data partitions. The intermediate shuffle data can be streamed between the worker nodes and a cluster resource manager, such as the SQL engine 142 or server environment 118 of the cloud data platform 102.

In other examples, a JDBC or ODBC driver can exist on a server-side of the cloud data platform 102, such as server environment 118. For example, the server environment 118 can include a presentation server implementation code that provides server-side functionality via the network 106 to the client environment 116. In some embodiments, the user of the client device(s) 114 can be a data provider configured to provide services to other users, such as data consumers 115. While certain functions of the computing environment 100 are described herein as being performed by either a client environment 116 or by the server environment 118, the location of certain functionality either within the client environment 116 or the server environment 118 may be a design choice. For example, it may be technically preferable to initially deploy particular technology and functionality within the server environment 118 but to later migrate this technology and functionality to the client environment 116 where a user system, such as the client device(s) 114, has sufficient processing capacity.

In the description below, actions are ascribed to users of the cloud data platform. Such actions shall be understood to be performed concerning client device(s) 114 (or a singular client device) operated by such users. For example, a notification to a user may be understood to be a notification transmitted to the client device(s) 114, input or instruction from a user may be understood to be received by way of the client device(s) 114, and interaction with an interface by a user shall be understood to be interaction with the interface on the client device(s) 114. In addition, database operations (e.g., joining, aggregating, analysis, etc.) ascribed to a user of the cloud data platform shall be understood to include performing such actions by the cloud computing service 103 in response to an instruction from that user.

The compute service manager 108 is also coupled to one or more metadata databases 112 that store metadata about various functions and aspects associated with the cloud data platform 102 and its users. For example, the one or more metadata databases 112 may include a summary of data stored in remote data storage systems as well as data available from a local cache. Additionally, the one or more metadata databases 112 may include information regarding how data is organized in remote data storage systems (e.g., the storage platform 104) and the local caches. Information stored by the one or more metadata databases 112 allows systems and services to determine whether a piece of data needs to be accessed without loading or accessing the actual data from a storage device. In some embodiments, the one or more metadata databases 112 are configured to store account object metadata (e.g., account objects used in connection with a replication group object).

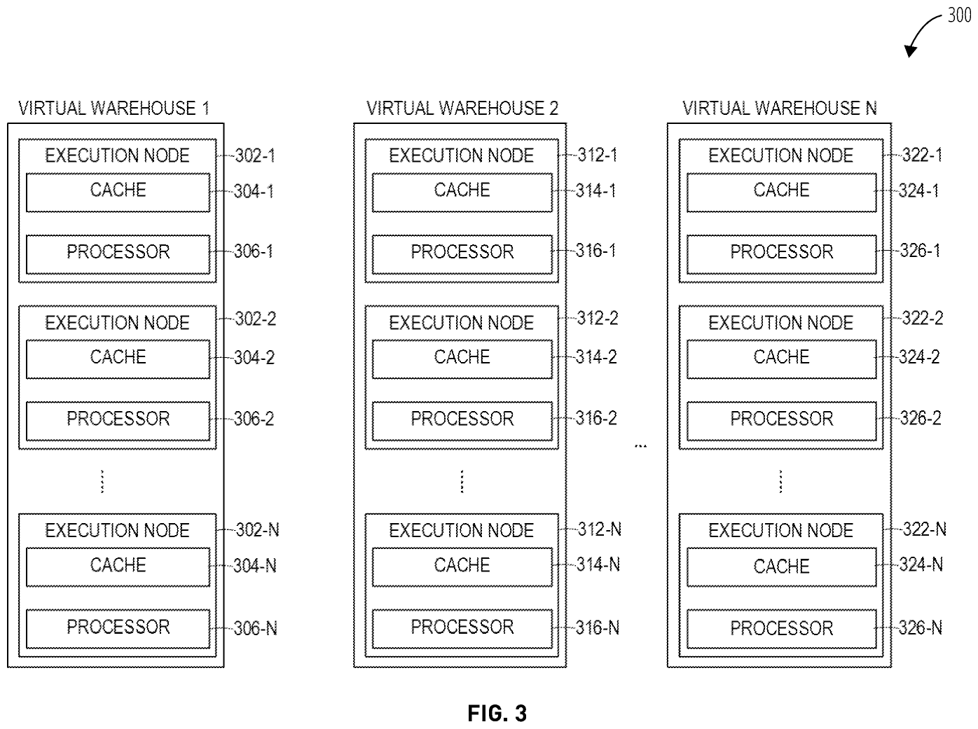

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud-storage platforms 122a, 122b . . . , 122c (collectively referred to as storage platforms 122). The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the storage platform 104 may include distributed file systems (such as Hadoop Distributed File Systems (HDFS)), object storage systems, and the like. In some embodiments, at least one internal stage 126 may reside on one or more of the data storage devices 120-1-120-N, and an external stage 124 may reside on one or more of the storage platforms 122.

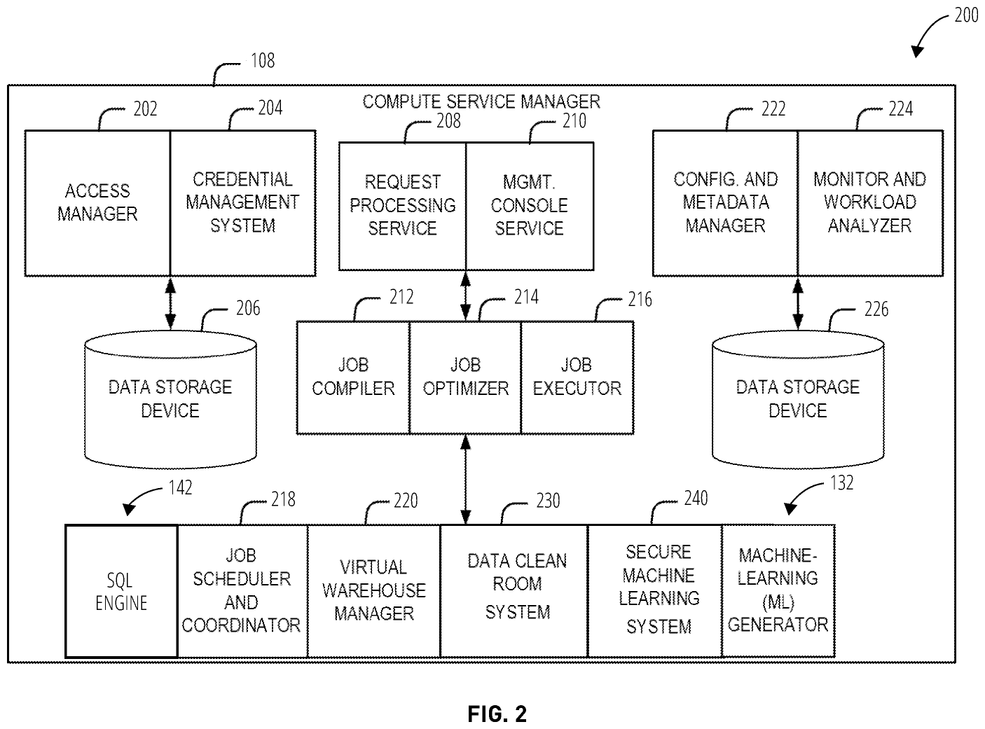

In some embodiments, the cloud data platform 102 includes a machine-learning (ML) generator 132. The ML generator 132 comprises suitable circuitry, interfaces, logic, and/or code and is configured to provide generation of ML models for extracting information from one or more documents (e.g., electronic documents) according to various embodiments. In some embodiments, the ML generator 132 can include one or more system functions that can be used to implement a method of generating an ML model as described herein. In some examples, the ML generator 132 can be operatively interconnected to the compute service manager 108, within the compute service manager 108 (as depicted in FIG. 2), connected to the execution platform 110, connected to the meta database(s) 112, or otherwise connected within or operatively to the cloud data platform 102 via additional external connections.

The execution platform 110 comprises a plurality of compute nodes. A set of processes on a compute node executes a query plan compiled by the compute service manager 108. The set of processes can include: a first process to execute the query plan; a second process to monitor and delete cache files using a least recently used (LRU) policy and implement an out of memory (OOM) error mitigation process; a third process that extracts health information from process logs and status to send back to the compute service manager 108; a fourth process to establish communication with the compute service manager 108 after a system boot; and a fifth process to handle all communication with a compute cluster for a given job provided by the compute service manager 108 and to communicate information back to the compute service manager 108 and other compute nodes of the execution platform 110.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

The compute service manager 108, the one or more metadata databases 112, the execution platform 110, and the storage platform 104, are shown in FIG. 1 as individual discrete components. However, each of the compute service manager 108, the one or more metadata databases 112, execution platform 110, and storage platform 104 may be implemented as a distributed system (e.g., distributed across multiple systems/platforms at multiple geographic locations). Additionally, each of the compute service manager 108, the one or more metadata databases 112, execution platform 110, and storage platform 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

During a typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be good candidates for processing the task. Metadata stored in the one or more metadata databases 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the storage platform 104. It is desirable to retrieve as much data as possible from caches within the execution platform 110 because the retrieval speed is typically much faster than retrieving data from the storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the storage platform 104. Thus, the computing resources and cache resources are not restricted to specific data storage devices 120-1 to 120-N. Instead, all computing resources and all cache resources may retrieve data from, and store data to, any of the data storage resources in the storage platform 104.

FIG. 2 is a block diagram 200 illustrating components of the compute service manager 108, in accordance with some embodiments of the present disclosure. As shown in FIG. 2, the compute service manager 108 includes an access manager 202 and a credential management system 204 coupled to data storage device 206, which is an example of the metadata databases 112. Access manager 202 handles authentication and authorization tasks for the systems described herein.

The credential management system 204 facilitates use of remote stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the data storage device 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the data storage device 206 (e.g., access metadata database, a credential object, and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in cloud storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110 of FIG. 1. For example, jobs may be prioritized and then processed in the prioritized order. In an embodiment, the job scheduler and coordinator 218 determines a priority for internal jobs that are scheduled by the compute service manager 108 of FIG. 1 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries, requests, or the like.

As illustrated, the compute service manager 108 includes a configuration and metadata manager 222, which manages the information related to the data stored in the remote data storage devices and in the local buffers (e.g., the buffers in execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 represents any data storage device within the cloud data platform 102. For example, data storage device 226 may represent buffers in execution platform 110, storage devices in cloud storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1 of FIG. 3) may need to communicate with another execution node (e.g., execution node 302-2 of FIG. 3), but should be disallowed from communicating with a third execution node (e.g., execution node 312-1), and any such illicit communication can be recorded (e.g., in a log or other location). Also, the information stored on a given execution node is restricted to data relevant to the current query, and any other data is unusable, rendered so by destruction or encryption where the key is unavailable.

The data clean room system 230 allows for dynamically restricted data access to shared datasets. Data clean room is one part of data sharing and is just one example of the marketplace.

The compute service manager 108 can include a SQL engine 142 and/or be operatively connected to the SQL engine 142 configured to generate dynamic pivot functionality via a database system backend, such as the server environment 118 or the SQL engine 142, transforms data into optimized queries using object aggregation, deterministic ordering, or the like to efficiently compute results of the SQL query 138 including the dynamic pivot, in accordance with example embodiments of the present disclosure.

As previously mentioned, the compute service manager 108 can include the ML generator 132 and/or be operatively interconnected to the ML generator 132 configured to generate ML model for extracting information from one or more documents according to various embodiments. As explained throughout, in some example embodiments, the ML generator 132 can be integrated into a database clean room, and/or used in conjunction with, parallel to, or in combination with a secure machine learning system 240 as depicted and described above with reference to FIG. 2. The database clean room enables two or more end-users of the cloud data platform 102 to share and collaborate on their sensitive data, without directly revealing that data to other participants. In alternative example embodiments, the ML generator 132 can be configured externally from compute service manager 108 and from cloud data platform 102, instead being operatively interconnected via one or more layers.

FIG. 3 is a block diagram 300 illustrating components of the execution platform 110 of FIG. 1, in accordance with some embodiments of the present disclosure. As shown in FIG. 3, the execution platform 110 includes multiple virtual warehouses, including virtual warehouse 1, virtual warehouse 2, and virtual warehouse N. Each virtual warehouse includes multiple execution nodes that each include a data cache and a processor. The virtual warehouses can execute multiple tasks in parallel by using the multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer useful.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternate embodiments may include execution nodes containing any number of processors and any number of caches. Additionally, the caches may vary in size among the different execution nodes. The caches shown in FIG. 3 store, in the local execution node, data that was retrieved from one or more data storage devices in cloud storage platform 104 of FIG. 1. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet, another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault tolerant. For example, if one virtual warehouse fails, that virtual warehouse is quickly replaced with a different virtual warehouse at a different geographic location. A particular execution platform of the execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer useful.

In some embodiments, the virtual warehouses may operate on the same data in storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance.

FIG. 4 is a computing environment 400 conceptually illustrating an example software architecture executing a user-defined function (UDF) by a process running on a given execution node of the execution platform 110 of FIG. 3, in accordance with some embodiments of the present disclosure.

As illustrated, the execution node 302-1 from the execution platform 110 includes an execution node process 410, which in an embodiment is running on the processor 306-1 and can also utilize memory from the cache 304-1 (or another memory device or storage). As mentioned herein, a “process” or “computing process” can refer to an instance of a computer program that is being executed by one or more threads by an execution node or execution platform.

As mentioned before, the compute service manager 108 of FIG. 1 validates all communication from the execution platform 110 of FIG. 1 to validate that the content and context of that communication are consistent with the task(s) known to be assigned to the execution platform 110. For example, the execution platform 110 executing a query A is not allowed to request access to a particular data source (e.g., data storage device 226 of FIG. 2 or any one of the storage devices in the storage platform 104) that is not relevant to query A. In an example, the execution node 302-1 may need to communicate with a second execution node (e.g., execution node 302-2), but the security mechanisms described herein can disallow communication with a third execution node (e.g., execution node 312-1). Moreover, any such illicit communication can be recorded (e.g., in a log 444 or other location). Further, the information stored on a given execution node is restricted to data relevant to the current query and any other data is unusable by destruction or encryption where the key is unavailable.

The execution node process 410 is executing a UDF client 412 in the example of FIG. 4. In an embodiment, the UDF client 412 is implemented to support UDFs written in a particular programming language such as JAVA, and the like. In an embodiment, the UDF client 412 is implemented in a different programming language (e.g., C or C++) than the user code 430, which can further improve security of the computing environment 400 by using a different codebase (e.g., one with the same or fewer potential security exploits).

User code 430 may be provided as a package, e.g., in the form of a JAR (JAVA archive) file which includes code for one or more UDFs. Server implementation code 432, in an embodiment, is a JAR file that initiates a server which is responsible for receiving requests from the execution node process 410, assigning worker threads to execute user code, and returning the results, among other types of server tasks.

In an implementation, an operation from a UDF (e.g., JAVA-based UDF) can be performed by a user code runtime 424 executing within a sandbox process 420. In an embodiment, the user code runtime 424 is implemented as a virtual machine, such as a JAVA virtual machine (JVM). Since the user code runtime 424 executes in a separate process relative to the execution node process 410, there is a lower risk of manipulating the execution node process 410. Results of performing the operation, among other types of information or messages, can be stored in a log 444 for review and retrieval. In an embodiment, the log 444 can be stored locally in memory at the execution node 302-1, or at a separate location such as the cloud storage platform 104.

Examples of the log 444 can include logging for observability and debuggability. Logging can be automatically configured to observe egress traffic using a logging mechanism with runtime-configurable verbosity levels. For example, use of an event output log or event output helper can allow for passing custom structs from the eBPF program to a performance event ring buffer along with an optional packet sample. In response, the execution platform worker can pull the logs from log 444 or other logs from the buffer and write to execution platform logs, as an example. This channel can be used to log, debug, sample, and/or push notifications for network policy violations and the like. For example, the event output log or helper can be configured to pass the data through a lockless memory mapped per-CPU performance ring buffer, which is significantly faster (e.g., more efficient) than default logging support in eBPF.

Additional examples of the log 444 or other logs of the cloud data platform 102 can be used to provide clear and actionable feedback necessary for users if their UDF's packet has been blocked. With the logging mechanism, the cloud data platform 102 or component thereof can report details back to the user (e.g., which IP and port has been blocked or violated the account policy). Additionally, when an unauthorized DNS request has been blocked, the eBPF program can intercept the packet and report back which hostname it tried to access and enter such information into the log 444, which is valuable for helping customers to troubleshoot and debug their UDF.

Moreover, such results can be returned from the user code runtime 424 to the UDF client 412 utilizing a high-performance protocol (e.g., without serialization or deserialization of data, without memory copies; operates on record batches without having to access individual columns, records, or cells; utilizes efficient remote procedure call techniques and network protocol(s) for data transfer) for data transfer (e.g., distributed datasets) that further provides authentication and encryption of the data transfer. In an embodiment, the UDF client 412 uses a data transport mechanism that supports a network transfer of columnar data between the user code runtime 424 (and vice-versa).

Security manager 422, in an example, can prevent completion of an operation from a given UDF by throwing an exception (e.g., if the operation is not permitted), or returns (e.g., doing nothing) if the operation is permitted. In an implementation, the security manager 422 is implemented as a JAVA security manager object that allows applications to implement a security policy such as a security manager policy 442, and enables an application to determine, before performing a possibly unsafe or sensitive operation, what the operation is and whether it is being attempted in a security context that allows the operation to be performed. The security manager policy 442 can be implemented as a file with permissions that the user code runtime 424 is granted. The application (e.g., UDF executed by the user code runtime 424) therefore can allow or disallow the operation based at least in part on the security policy.

Sandbox process 420, in an embodiment, is a sub-process (or separate process) from the execution node process 410. A sub-process, in an embodiment, refers to a child process of a given parent process (e.g., in this example, the execution node process 410). The sandbox process 420, in an example, is a program that reduces the risk of security breaches by restricting the running environment of untrusted applications using security mechanisms such as namespaces and secure computing modes (e.g., using a system call filter to an executing process and all its descendants, thus reducing the attack surface of the kernel of a given operating system). Moreover, in an example, the sandbox process 420 is a lightweight process in comparison to the execution node process 410 and is optimized (e.g., closely coupled to security mechanisms of a given operating system kernel) to process a database query in a secure manner within the sandbox environment.

For example, the instance of a computer program can be instantiated by the execution platform 110. For example, the execution node 302-1 can be configured for instantiating a user code runtime to execute the code of the UDF and/or to create a runtime environment that allows the user's code to be executed. The user code runtime can include an access control process including an access control list, where the access control list includes authorized hosts and access usage rights or other types of allow lists and/or block lists with access control information. Instantiating a sandbox process can determine whether the UDF is permitted and instantiating the user code runtime as a child process of the sandbox process, the sandbox process configured to execute the at least one operation in a sandbox environment.

In an embodiment, the sandbox process 420 can utilize a virtual network connection in order to communicate with other components within the subject system. A specific set of rules can be configured for the virtual network connection with respect to other components of the subject system. For example, such rules for the virtual network connection can be configured for a particular UDF to restrict the locations (e.g., particular sites on the Internet or components that the UDF can communicate) that are accessible by operations performed by the UDF. Thus, in this example, the UDF can be denied access to particular network locations or sites on the Internet.

The sandbox process 420 can be understood as providing a constrained computing environment for a process (or processes) within the sandbox, where these constrained processes can be controlled and restricted to limit access to certain computing resources.

Examples of security mechanisms can include the implementation of namespaces in which each respective group of processes executing within the sandbox environment has access to respective computing resources (e.g., process IDs, hostnames, user IDs, file names, names associated with network access, inter-process communication, and the like) that are not accessible to another group of processes (which may have access to a different group of resources not accessible by the former group of processes), other container implementations, and the like. By having the sandbox process 420 execute as a sub-process to the execution node process 410, in some embodiments, latency in processing a given database query can be substantially reduced (e.g., a reduction in latency by a factor of 10× in some instances) in comparison with other techniques that may utilize a virtual machine solution by itself.

As further illustrated, the sandbox process 420 can utilize a sandbox policy 440 to enforce a given security policy. The sandbox policy 440 can be a file with information related to a configuration of the sandbox process 420 and details regarding restrictions, if any, and permissions for accessing and utilizing system resources. Example restrictions can include restrictions to network access, or file system access (e.g., remapping file system to place files in different locations that may not be accessible, other files can be mounted in different locations, and the like). The sandbox process 420 restricts the memory and processor (e.g., CPU) usage of the user code runtime 424, ensuring that other operations on the same execution node can execute without running out of resources.

As mentioned above, the sandbox process 420 is a sub-process (or separate process) from the execution node process 410, which in practice means that the sandbox process 420 resides in a separate memory space than the execution node process 410. In an occurrence of a security breach in connection with the sandbox process 420 (e.g., by errant or malicious code from a given UDF), if arbitrary memory is accessed by a malicious actor, the data or information stored by the execution node process is protected.

Although the above discussion of FIG. 4 describes components that are implemented using JAVA (e.g., an object-oriented programming language), it is appreciated that the other programming languages (e.g., interpreted programming languages) are supported by the computing environment 400. In an embodiment, PYTHON is supported for implementing and executing UDFs in the computing environment 400. In this example, the user code runtime 424 can be replaced with a PYTHON interpreter for executing operations from UDFs (e.g., written in PYTHON) within the sandbox process 420.

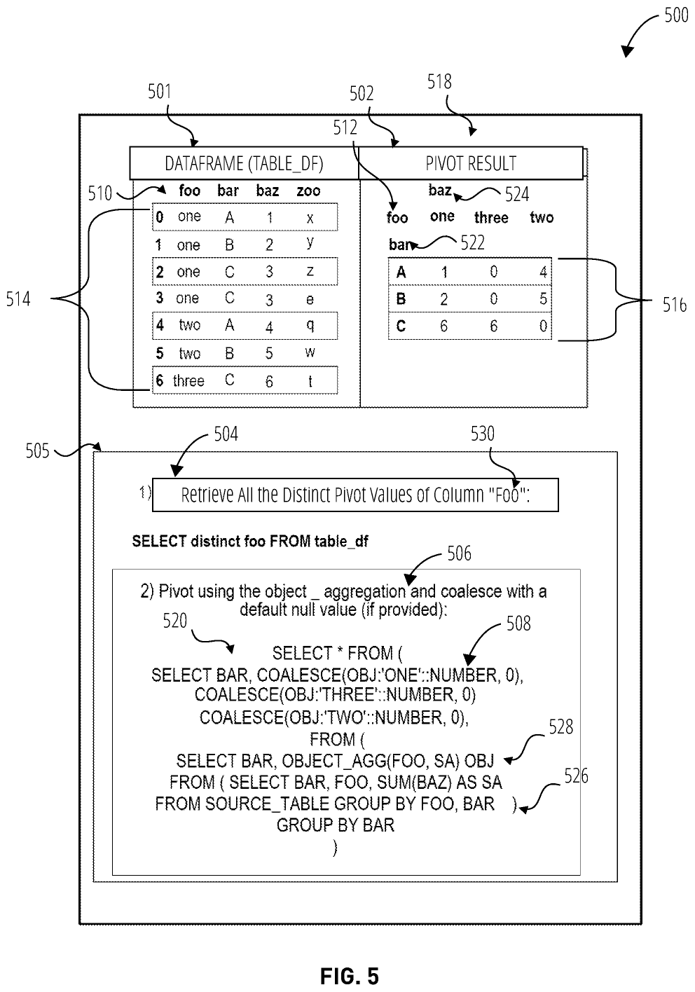

FIG. 5 is a block diagram 500 illustrating a concrete example of a developer framework and programming environment DataFrame API used by a user (e.g., data engineer) to execute a dynamic pivot on a pivot table on larger cloud data platform tables, according to one example embodiment.

According to an example embodiment of the dynamic pivot implementation, the underlying performance is improved, and the dynamic pivot is provided by extending an existing SQL pivot operator syntax and is used through the developer framework and programming environment of the cloud data platform and the DataFrame API. An example of the SQL dynamic pivot would be: SELECT * FROM (select bar, foo, baz from table_DF) PIVOT (sum (baz) FOR foo IN (ANY) DEFAULT ON NULL (0)). A pivot result chart 502, such as a pivot table, illustrates the pivot result from DataFrame 501.

A pivot table, such as pivot result chart 502, is an interactive data visualization tool that allows users to rearrange and summarize tabular data for analysis. The pivot table visualization provides a graphical representation of the transformed data from DataFrame 501 by pivoting rows 510 into columns, applying aggregate functions, filtering, sorting, and additional configuration options specified by the user. This enables data, such as compressed data 516, to be presented in a compressed yet insightful multi-dimensional view highlighting trends and relationships not readily apparent from raw data 514 alone. The visualization 518 is driven by an underlying dynamic pivot query 520 that transforms the source data, such as raw data 514, into the desired summarized layout. As the source data changes, the associated changes can be dynamically reflected in the visualization 518. The interactive capabilities of pivot tables provide a versatile analysis tool for obtaining macro insights into detailed datasets across business domains.

For example, in DataFrame 501, the chart shows a DataFrame with an index column and pivot column 512 labeled ‘foo,’ ‘bar,’ ‘baz,’ and ‘zoo.’ The pivot result chart 502 shows the pivot result with pivot column 512 labeled ‘foo,’ aggregation column 524 labeled ‘baz,’ index column 522 labeled ‘bar,’ and filling value ‘0.’ For simplicity of understanding, ‘foo’ and ‘baz’ can be ignored, and the final result in pivot result chart 502 will have four columns, labeled ‘bar,’ ‘one,’ ‘three,’ and ‘two.’

According to an example of the developer framework and programming environment DataFrame API 505, to achieve the functionality with SQL support in the cloud data platform according to some examples, the dynamic pivot is performed in multiple steps 504, 506, and 508. While three steps are shown in the example embodiment of FIG. 5, it will be understood by one of ordinary skill in the art that one or more additional steps, fewer steps, and/or different arrangement of steps may similarly apply to examples of the present disclosure.

The first step 504 includes retrieving all of the distinct pivot values of column ‘foo’ from the DataFrame 501 by issuing a select distinct first to get all distinct values of pivot column ‘foo.’ The second step 506 includes calling pivot on the returned results (e.g., pivot using the object_aggregation). The third step 508, if necessary, includes calling coalesce on each column of the pivot result to replace NULLs with zero (0) (e.g., coalescing with a default on null value if provided). For example, ‘foo’ is the pivot column 512, and the values of ‘foo’ from raw data 514 (e.g., one, two, three) become the new columns in a result visualization. The reference query 526 has “from source_table” and “GROUP BY bar.” The object aggregation 528 has “OBJECT_AGG (foo, sa)” as the query is aggregated with ‘foo’ as the key 530.

Specifically, according to the steps 504, 506, and 508, the SQL queries that must be performed include: First step 504, includes table_df being the table representation of DataFrame df, which retrieves all of the distinct pivot values of column ‘foo’ (e.g., SELECT DISTINCT foo FROM table_df ORDER BY foo). Second step 506, runs pivot and third step 508 runs coalesce SELECT bar, coalesce(“one”, 0) as one, coalesce (“three”, 0) as two, coalesce (“two”, 0) as three FROM (select bar, foo, baz from table_df) PIVOT (sum(‘baz’) FOR ‘foo’ IN (‘one’, ‘three’, ‘two’)). In other words, the cloud data platform (e.g., via a backend server) internally rewrites the underlying dynamic pivot query 520 in multiple steps 504, 506, and 508. At step 504, retrieving all the distinct pivot values of column ‘bar’ is written as: SELECT distinct foo FROM table_df. At second step 506, pivot using the object_aggregation, and at third step 508, coalesce with a default null value (if provided) is written as: SELECT * FROM (SELECT bar, coalesce(OBJ:‘one’::number, 0), coalesce (OBJ:‘two’::number, 0), coalesce(OBJ:‘three’::number, 0) FROM (SELECT bar, OBJECT_AGG(foo, sa) OBJ FROM (SELECT bar, foo, sum (baz) as sa FROM source_table GROUP BY foo, bar) GROUP BY bar).

According to some examples, output columns are determined at runtime in the first step 504, such that there is also an ORDER BY clause that can be provided to determine the order of the output columns. In some examples, by default, it is lexicographical if not specified.

According to some examples, an incompatible pivot value can exist with type matching; however, the pivot view with object aggregations returns a valid response with NULL since there is no implicit type checking between the pivot values and pivot column in the query. In this particular case, there is a GET ($OBJ, null+1), which returns a NULL. In additional examples, the pivot view is extended with object_agg with a ‘where’ clause to filter on the pivot values to address the type checking and be more efficient. According to some examples, the ‘where’ clause is not added for a dynamic pivot when it is not needed there.

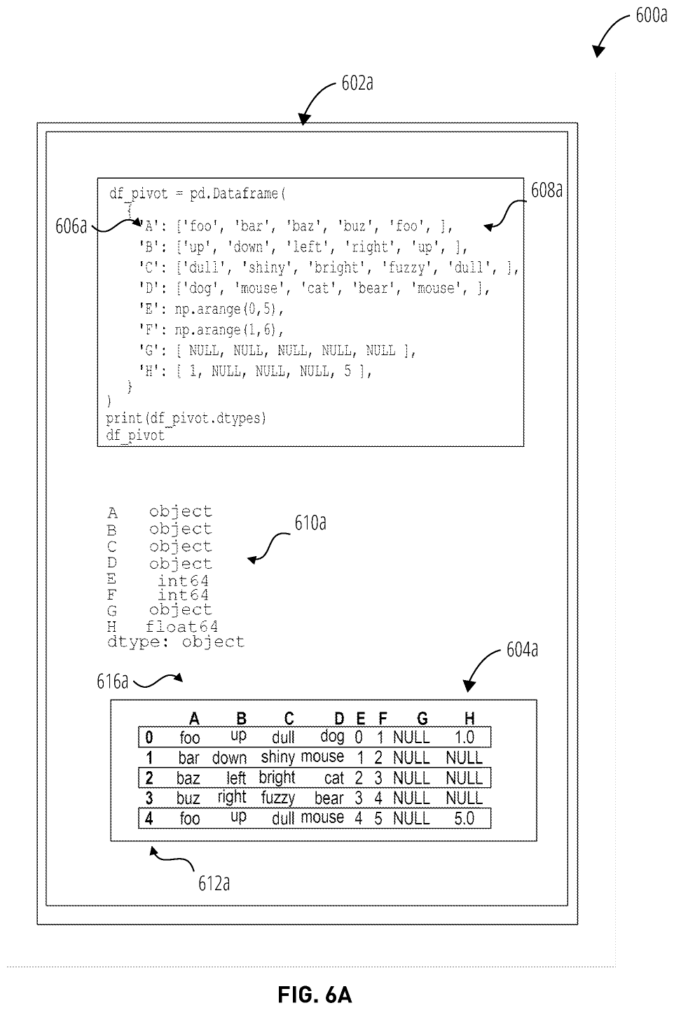

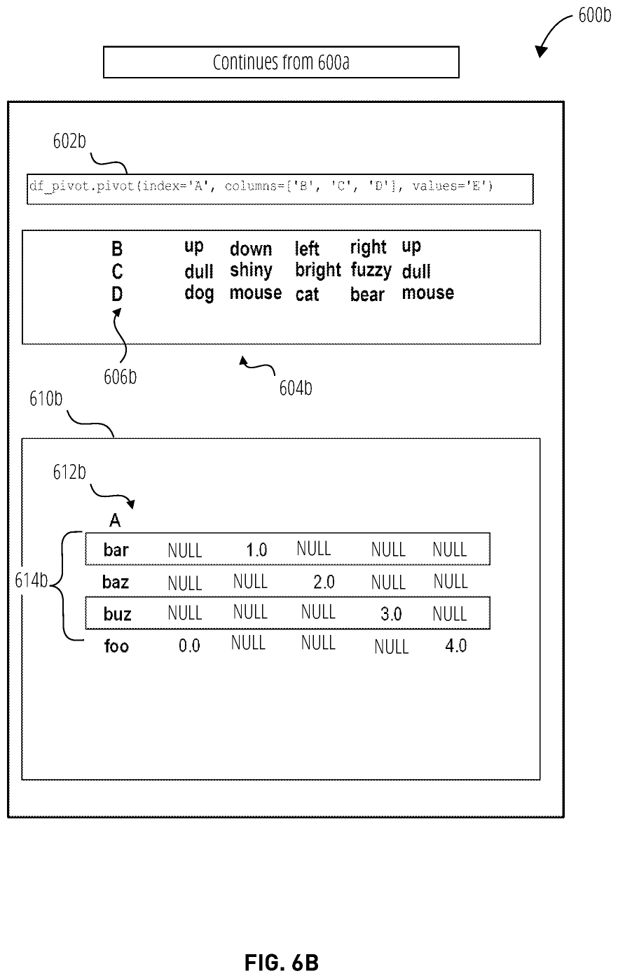

FIG. 6A is a block diagram 600a illustrating a dataset in which a dynamic pivot functionality is used to create a DataFrame, in accordance with one example embodiment. The developer framework and programming environment DataFrame service of the cloud data platform includes a pivot and/or a dynamic pivot API.

Example embodiments provide for manipulating the DataFrame to alter the representation of the data for additional data processing and summarization using a dynamic pivot function to group unique values within discrete groups. The API returns a reshaped DataFrame organized by given index (e.g., row) values and column values. Then a pivot table is produced by reshaping the data based on the column values, where unique values are used from a specified index and/or columns to form axes of the resulting DataFrame.

According to the example embodiments for reshaping the DataFrame, parameters can include a column to use to make new frame's columns (e.g., str or object or a list of str), and can also accept a list of column names. A parameter column to use to make the new frame's index (e.g., str or object or a list of str), which may be optional. If not given, it uses the existing index, and can also accept a list of index names. Column(s) to use for populating the new frame's values (e.g., str, object or a list of the previous), which may be optional. If not specified, all remaining columns will be used, and the result will have hierarchically indexed columns. Use DataFrame.pivot when you need to aggregate.

In block diagram 600a, in the DataFrame pivot operation 602a, where the letters A-H each represent a column label followed by data values associated with each column label A-H that exists in a table or database in the cloud data platform. For example, in DataFrame pivot operation 602a, there are multiple dataset values 608a for column 606a labeled “A,” where the dataset values 608a include five values labeled ‘foo,’ ‘bar,’ ‘baz,’ ‘buz,’ and ‘foo.’ The DataFrame pivot operation 602a produces DataFrame 604a as output by taking the values for each corresponding column label A-H and dynamically pivoting (e.g., rotating) the columns to be rows in the DataFrame 604a.

DataFrame 604a organizes the data values into a table with pivoted columns 616a, which are rotated into labeled rows and new columns 612a that can store a variety of data types 610a (e.g., object, integer, float, etc.). If the index and pivot grouping is extended with pivoted columns 616a to column ‘D’ in the DataFrame 604a, then there is no error since there is no value or a unique value for the aggregation value. However, if the index and pivot grouping is extended with pivoted columns 616a E, F, G, and/or H, a value error may occur when the index contains duplicate entries that cannot be reshaped (e.g., dynamically pivoted).

In additional examples, the function may not support data aggregation, and multiple values will result in a multi-index in the columns. While normally in SQL, a column identifier can be thought of as one string; however, in PANDAS, a column identifier can be a tuple with multiple components. As such, example embodiments using dynamic pivot support multiple level labels (as used in PANDAS-compatible DataFrames or other DataFrames), such as a pair or tuple of labels (that are separate and used in a grouping sense for that column). Where “up, dull, dog” can be expressed as one label.

In some examples, if there is no filling value specified, the 0s in the DataFrame 604a, referred to as the pivot result, will be written as missing value as represented by “NULL”. A missing value (e.g., None, Not a Number (NaN), null, etc.) is a placeholder if there is no value for the label component, and used to identify missing label components, which is also applied in examples and used to identify when there is no data. For example, all missing values are mapped to NULL. The underlying pivot can be done using a cloud data platform pivot, however, there are some differences relative to the semantics of PANDAS' pivot_table. For example, ordering and dropna may be different. Regarding ordering, PANDAS pivot no SORT option, the pivot columns are ordered based on the order they occur inside the original DataFrame, while the rows are ordered in alphabetical order. This is inconsistent with pivot_table sort semantics that does one or the other for pivot columns and rows. Regarding dropna, PANDAS pivot does not drop columns with all missing values (e.g., None/NaN columns) and it does not add None/NAN values either. According to example embodiments, for example, if the values data set is all None/NaN, then pivot_table dropna=True would drop this row and if dropna=False it may add one or more rows to obtain the cartesian product of pivot values. Neither of these matches the semantics of pivot that does not drop or add rows/groupings/columns.

According to additional example embodiments, data is often stored in either a stacked or record format. In a record format, also referred to as a wide format, there is generally a single row in a table for each subject, with different attributes of that subject stored in separate columns. In a stacked format, also known as a long format, there are multiple rows in a table for a given subject, with each row containing a different attribute for that subject. The long format thereby has data stacked vertically across multiple rows, while the wide format stores data horizontally across columns for each subject. Dynamic pivot operations can be similarly applied to these and other formats.

FIG. 6B is a block diagram 600b, which continues from block diagram 600a, illustrating a dataset in which a dynamic pivot operation is used to create a DataFrame 610b, in accordance with one example embodiment.

According to the example embodiment, the SQL query 602b includes a dynamic pivot operation acting on the index column A 612b from DataFrame pivot operation 602a on columns B, C, and D 606b from dataset 604b. The SQL query 602b includes a dynamic pivot operation using the values of column E from DataFrame pivot operation 602a. The values 608a from column A 612b are dynamically pivoted to include non-repeating values as new rows 614b represented as “bar,” “baz,” “buz,” and “foo.” The values of the new rows 614b will be completed per the SQL query 602b from column E, which include “1.0” for “bar,” “2.0” for “baz,” “3.0” for “buz,” and “4.0” for “foo.” All other values are entered as “NULL” in the DataFrame 610b, or in alternative example embodiments, another non-value number holder.

Additional examples of the dynamic pivot capability enable efficient distributed execution of advanced analytic transformations invoked through client facing DataFrame APIs, the client facing DataFrame APIs operatively connected to the developer framework and programming environment DataFrame service of the cloud data platform 102, such as through the SQL engine 142. Examples include pivoting DataFrames on dimensions like time, geography, or other categories to reshape raw data from long to wide formats for aggregation, reporting, and visualization. Multi-pivots can generate cross-tabulations and data cubes using different columns, where adding margins provides totals across rows or columns, and transposing flips axes for alternating between wide and long layouts.

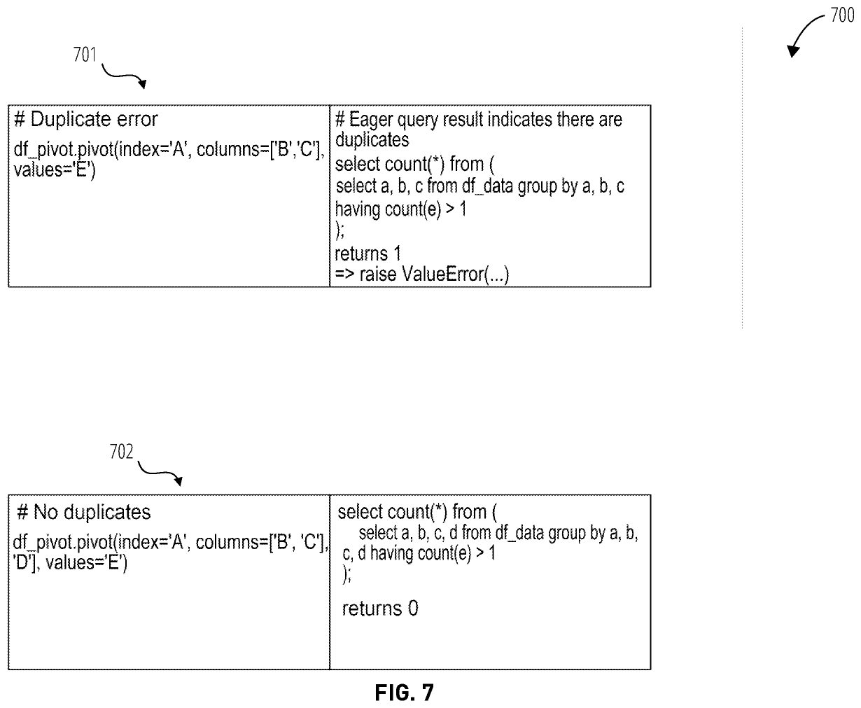

FIG. 7 is a block diagram 700 illustrating PANDAS-compatible semantics employed inside a cloud data platform 102 workload for handling duplication errors, in accordance with one example embodiment.

Implementation 701 includes example PANDAS-compatible semantics to determine whether the dynamic pivot operation contains duplicates by employing (e.g., relying on) a cloud data platform SQL GROUP BY operation. The GROUP BY operation identifies there are duplication issues in the pivot operation by returning a “1.”

Implementation 702 includes example PANDAS-compatible semantics to determine that the dynamic pivot operation does not contain duplicates by employing (e.g., relying on) a cloud data platform SQL GROUP BY operation. The GROUP BY operation identifies there are no duplication issues in the pivot operation by returning a “0.”

Additional examples can include alternative semantics to identify issues with duplication in accordance with example embodiments of the present disclosure.

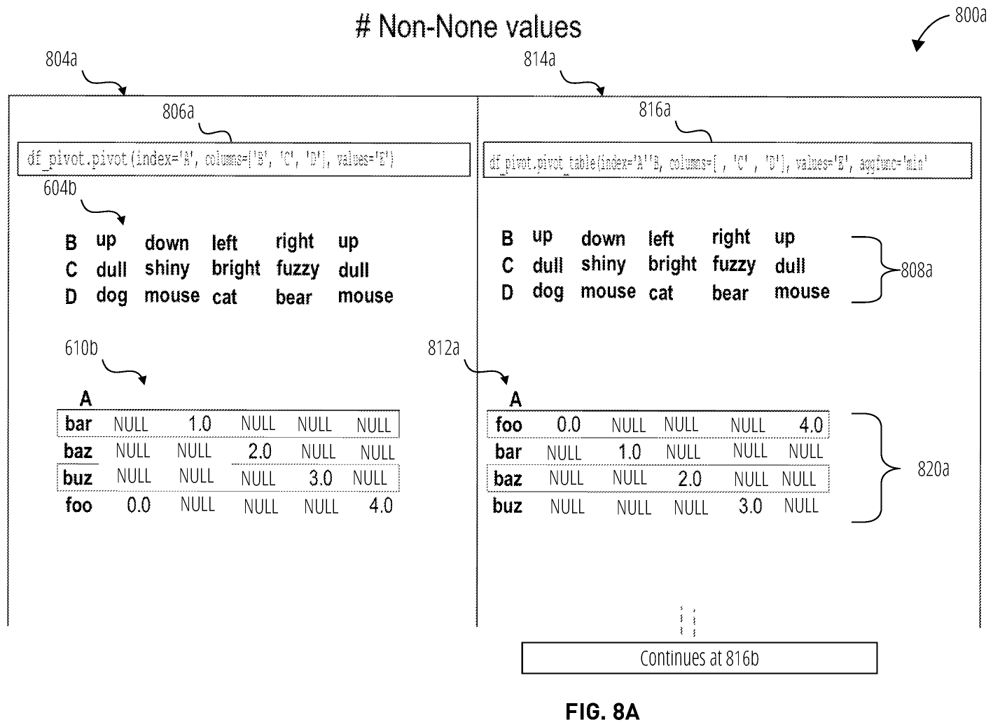

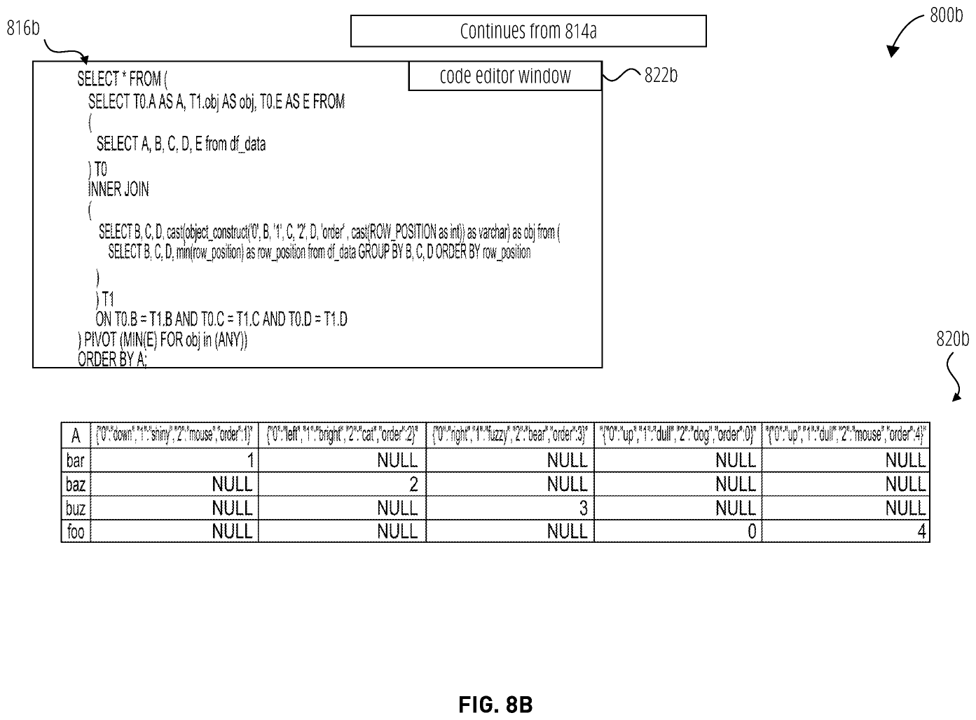

FIG. 8A is a block diagram 800a illustrating SQL queries including dynamic pivot subqueries 806a and 816a including dataset values operated on by the dynamic pivot subquery for all non-NONE values, according to one example embodiment of the present disclosure. FIG. 8A is similar in many respects to FIGS. 6A-6B, sharing certain similar features and components. For brevity, only specific elements are detailed and described with reference to FIG. 8A.

The block diagram 800a includes a left portion 804a and a right portion 814a. The left portion 804a includes a dynamic pivot subquery 806a operating on non-none values. The right portion 814a includes an explanation of the dynamic pivot subquery 816a being executed like a modified pivot table operation according to examples of the present disclosure.

Turning to the left portion 804a, for exemplary purposes, it includes the same example dataset 604b and the DataFrame 610b as described and depicted in connection with FIG. 6B, which are not repeated.

Turning to the right portion 814a, the rows need to be sorted by original row position, and then the output of DataFrame 812a will be the same or similar to the output of DataFrame 610b shown in the left portion 804a. For example, to guarantee the columns output in the expected order matching (e.g., identical to, similar to, functionally similar, etc.) PANDAS-compatible semantics, example embodiments add an “order” field in the object value. The “order” field is added because the cloud data platform SQL pivot ORDER BY clause could require the row position to also be part of the GROUP BY clause, which would cause a break in the aggregation, according to examples of the present disclosure.

In additional examples, a dynamic pivot subquery that requires a DISTINCT clause may also cause a break in ordering according to examples of the present disclosure. For example: select * from foo pivot (sum(a) for b in (select b from b_table))). For example, the dynamic pivot subquery could return duplicates and the pivot values would not be known until the recursive subquery completes. In some cases where a DISTINCT clause does not preserve even if the dataset 808a is already distinct with correct ordering 820a, or other operations that would cause more expensive and/or time-consuming work than is necessary by implementing explicit subquery management. Example embodiments including queries with explicit management are described and depicted in connection with FIG. 8B.

FIG. 8B is a block diagram 800b that continues from right portion 814a of FIG. 8A illustrates SQL query 816b with explicit management and DataFrame 820b as output of the SQL query 816b illustrating a dynamic pivot operation with explicit management, according to one example embodiment of the present disclosure.

The block diagram 800b can be implemented on a user interface, on client device(s) 114, that include a sample dashboard interface showing pivot tables, charts, and graphs generated using the dynamic pivot capabilities in accordance with example embodiments of the present disclosure. The dashboard allows end users to visually analyze data aggregated across various dimensions. For example, an example developer environment interface with a code editor window 822b. The code editor window 822b illustrates sample code written in a programming language that uses the developer framework APIs to connect to the cloud data warehouse, execute a dynamic pivot query, and process the results. The sample dashboard can further provide the DataFrame 820b illustrating the output of SQL query 816b. It shows an example dynamic pivot query being constructed using the syntax extensions like “ANY” and “DEFAULT ON NULL.” Together these interfaces demonstrate potential front-end applications that can leverage the integrated programming environment, developer framework, and dynamic pivot features to unlock new use cases on top of the cloud data warehouse.

According to some examples, explicit management can include implicitly adding DISTINCT operations into a dynamic pivot subquery to manage no duplicate pivot values in the results. Other examples include de-duplicating the pivot results when there are a large number of pivot values. Additional examples include requiring the dynamic pivot subquery to be distinct to ensure there will not be any duplicate pivot values in the results. In such an additional example, if the user does not specify DISTINCT in the query, then the cloud data platform 102 or the developer framework 140 may fail the query from the DataFrame API call 144 and inform the user to update the subquery.

Example embodiments of the dynamic pivot implementation includes a pivot syntax compiler to generate an additional number of columns depending on the pivot values listed in the syntax. For example, when the subquery or ANY keyword is used in the syntax, the compiler does not know the name of newly added columns and the count of columns. Example embodiments evaluate the given query or evaluate the target of the pivot table.

Example embodiments can improve pivot by extending a SQL pivot node (e.g., SqlPivot node) to take the following fields, for example: a) an extra Boolean field to indicate ‘ANY’ distinct value in the pivot column is used, b) a SqlSubQuery expression to record the subquery if specified, and c) a scalar expression for the default on NULL value. Example embodiments further include issuing a subquery via InterleavedExecution API (RecursiveQuery) to get the list of all the pivot values. If ANY is specified, query “SELECT DISTINCT <PivotColumnName> FROM <SourceTable>” will be used. Based on the query result, pivot outputColumns will be constructed. This evaluation happens right before the rewrite happens. Further examples perform a pivot rewrite, if default on null value is provided, a coalesce will be wrapped for each final pivot value column (but not the group by columns).

In example embodiments, the system includes end-user facing components like dashboards, reports, graphs, and other visualizations that could be generated leveraging the dynamic pivot capabilities and developer framework integration with the cloud data warehouse. Example interface figures could depict sample pivot tables, charts, developer environment UIs showing authored code, UI mockups for invoking syntax extensions like default pivot values, and query interfaces for accessing the cloud data warehouse through the developer framework. The envisioned outputs and user interfaces aim to build upon the underlying system architecture components described earlier to enable new use cases and capabilities utilizing the integrated programming environment and dynamic pivot features.

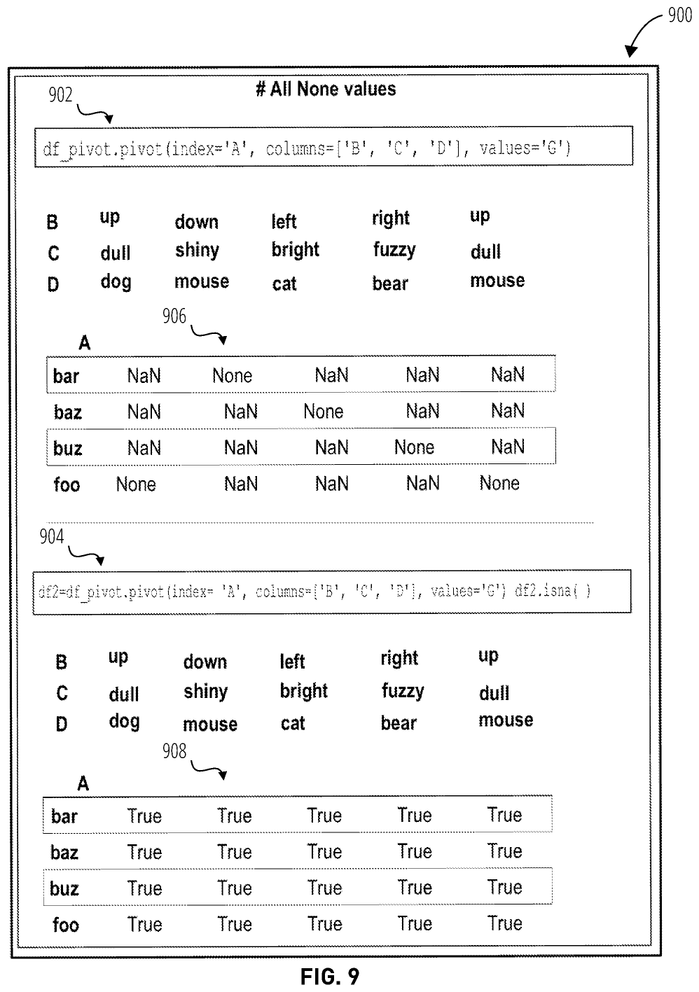

FIG. 9 is a block diagram 900 illustrating SQL queries including dynamic pivot subqueries 902 and 904 including dataset values operated on by the dynamic pivot subquery for all None values, according to one example embodiment of the present disclosure. FIG. 9 is similar in many respects to FIGS. 8A-8B, sharing certain similar features and components. For brevity, only specific elements are detailed and described with reference to FIG. 9.

The block diagram 900 illustrates resulting DataFrames with differing syntax in accordance with one example embodiment. In some examples, a dynamic pivot subquery 902 would output a first DataFrame 906 using syntax “None” and “NaN.” The dynamic pivot subquery 904 would output a second DataFrame 908 using syntax “True” for all values, whether the values are otherwise considered “None” or “NaN” values in PANDAS semantics. Even though the values in the first DataFrame 906 and the second DataFrame 908 display differently, the values are treated the same way, where each is treated as a missing value.

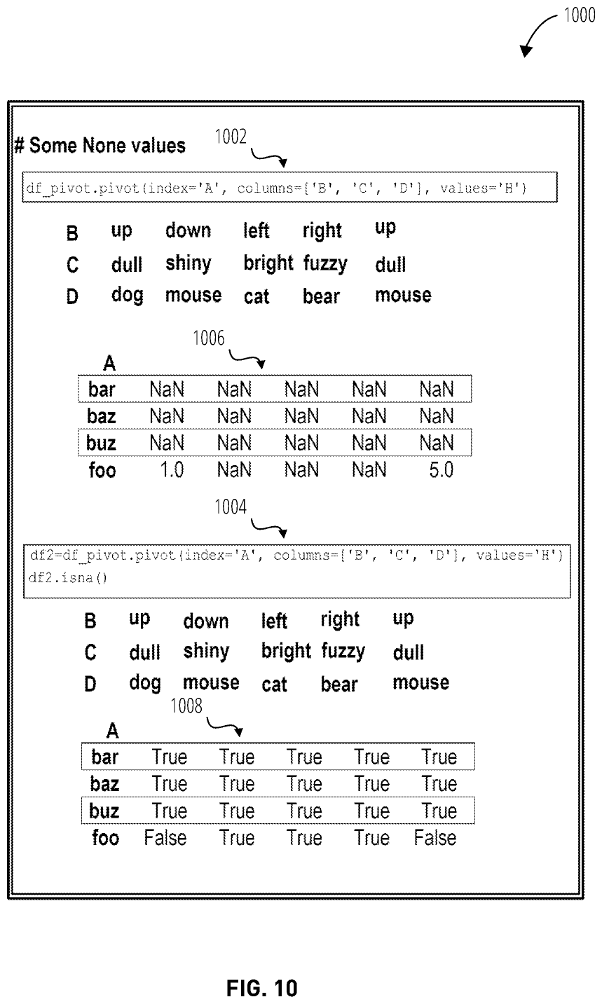

FIG. 10 is a block diagram 1000 illustrating SQL queries including dynamic pivot subqueries 1002 and 1004 including dataset values 608a operated on by the respective dynamic pivot subqueries for only some None values, according to one example embodiment of the present disclosure. FIG. 10 is similar in many respects to FIG. 9, sharing certain similar features and components. For brevity, only specific elements are detailed and described with reference to FIG. 10.

The block diagram 1000 illustrates resulting DataFrames with differing syntax in accordance with one example embodiment showing only some None values. The dynamic pivot subquery 1002 would output a first DataFrame 1006 using syntax “None” where a “None” value is identified from dataset values 608a as depicted and described in connection with FIG. 6A. The dynamic pivot subquery 1004 would output a second DataFrame 1008 using syntax “True” for all values where a “None” value is identified from dataset values 608a and “False” for all values where a non-None value is identified from dataset values 608a. Even though the values in the first DataFrame 1006 and the second DataFrame 1008 display differently, the values are treated the same way, where each “None” or “True” is treated as a missing value.

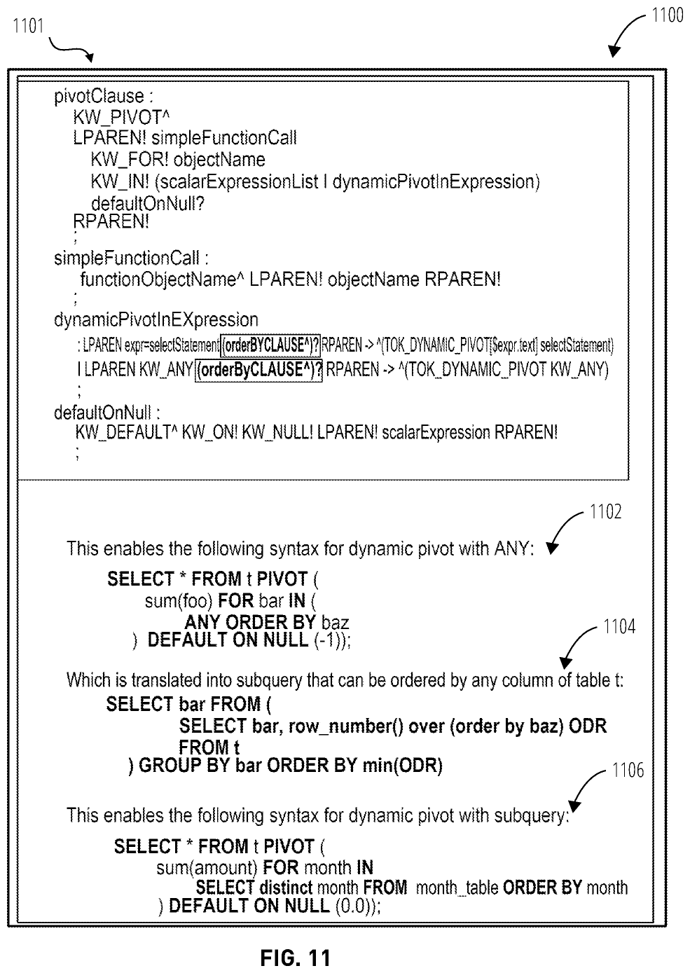

FIG. 11 is a block diagram 1100 illustrating a dynamic pivot ordering mechanism, according to one example embodiment.

For example, regarding SQL pivot as it has been extended for dynamic pivots, there are two primary issues to overcome using extended pivot grammar according to the present disclosure. The first issue relates to “ANY” and subquery, where the ordering of results of the recursive query are not specified and so can be any arbitrary ordering. Therefore, the resulting schema of the pivot result can have pivot value columns in arbitrary and inconsistent (across runs) ordering. The second issue relates to PANDAS, specifically, the pandas.pivot_table provides a “sort” parameter that can be true or false; however, the existing cloud data platform SQL dynamic pivot grammar does not have a way to specify an ordering. For example, the current cloud data platform SQL syntax for pivot is: SELECT * FROM (select bar, foo, baz from table_df) PIVOT (sum (baz) FOR bar IN (ANY) DEFAULT ON NULL (0)). The subquery syntax does not allow to specify ORDER BY.

In order to mitigate the issues above, example embodiments of the present invention provide for the dynamic pivot grammar to be extended according to the block diagram 1100 to include an ORDER BY clause, as shown in example code 1101. For example, if the query does not specify an explicit ORDER BY, then the syntax orders by the first column of the pivot subquery result (e.g., ANY/subquery). The distinct subquery can be wrapped by a query containing the ORDER BY $1 (e.g., identifying the first column of the source table). This ensures there is a deterministic ordering if the data does not change. If an explicit ORDER BY is provided, then for a subquery it is also required that it be an explicit DISTINCT query; this is because it would lose the ordering if it wrapped the subquery with a DISTINCT query otherwise.

As shown in FIG. 11, syntax at step 1102 enables syntax for dynamic pivot with ANY, and step 1104 takes the dynamic pivot from step 1102 and translates it into a subquery that can be ordered by any column of a table t according to step 1104. Step 1106 enables syntax for dynamic pivot with subquery.

In some examples using ANY and/or subquery, the dynamic subquery can return duplicates: for example: select * from foo pivot(sum(a) for b in (select b from b_table))). The pivot values would not be known until the recursive subquery completes, so if the subquery is blindly executed, it may perform more expensive and/or time-consuming work than is necessary. In order to overcome this challenge, examples implicitly add DISTINCT to the subquery. This guarantees there will not be any duplicate pivot values in the result. If the user examines the subquery, via an error message, a user interface, or the like, then it appears slightly modified from what the user originally provided, which may be surprising to a user. In other examples the pivot results can be de-duplicated. In additional examples, the pivot subquery is required to be distinct, which guarantees there will not be any duplicate pivot values in the result. If the user does not specify DISTINCT, then the subquery fails and sends the user a message to update the subquery.

In some examples using ANY and subquery, dynamic subquery could return multiple columns, for example: select * from foo pivot (sum(a) for b in (select * from b_table))). The subquery is validated for one select expression at parse time, so multiple select items are found it would fail; however, if a star is provided, it can later resolve to multiple columns. In order to overcome this challenge, examples validate the recursive query after preparation for the number of columns. In additional examples, this requires the expression not to include a star, which guarantees the column count will be accurate when checked at the parser level. If the user provides a star, then they will need to change their query to non-star select. In other examples, star expressions are allowed, and check the subquery results and fail if more than 1 column is returned.

In some examples nested dynamic pivots are implemented, for example: select abc, * from foo pivot (sum(a) for b in (any)) pivot(sum(e) for c in (any)) pivot (sum(f) for d in (any))). The nested pivot takes the results of the prior pivot as its source, so in the above example the recursive queries would be increasingly complex to build and result in significant duplication. Nested dynamic pivots involving only subqueries do not have this problem. In a first example: select distinct b from foo. In a second example: select distinct c from (select * from foo pivot (sum(a) for b in (any)))=>select distinct c from (select * from foo pivot (sum(a) for b in (select b from foo))). In a third example: select distinct d from (select * from foo pivot (sum(a) for b in (any)) pivot (sum(e) for c in (any)))=>select distinct d from (select * from foo pivot (sum(a) for b in (select b from foo)) pivot (sum(e) for c in (select distinct c from (select * from foo pivot (sum(a) for b in (select b from foo)

In additional examples, bindings for source view prone to SQL injection are implemented, for example: select * from (select b from foo) pivot (sum(a) for b in (any)). To avoid SQL injection attacks, bindings are used to generate the recursive query as such: select distinct identifier(:PIVOT_COL_BIND) from identifier(:PIVOT_SOURCE_BIND). However, this only works for the pivot column and when the source is a table object identifier, there is no way to resolve if the source is a view, since it would resolve as an identifier above. If the pivot source is a view, the SQL text (e.g., sqlText) is concatenated directly onto the end of the string. In some examples, the positional bindings in the query are converted into name bindings at an early stage based on position (:position_no). The first binding (?) is given bind name “:1”, the next bind name “2”. So, they are fully resolved to bind names. However, since it is passing the subquery as SQL text (e.g., sqlText) extracted during the initial parse, it does not contain the new bind name assignments. In this case, a subquery query block is visited, and a new binding map is built up that corresponds to the position of bind refs in that subquery. In additional examples, once a recursive query accepts a SQL query block (e.g., SqlQueryBlock) for execution, the cloud data platform can construct a query block correctly and directly pass it for execution.

Additional examples provided below, for exemplary purposes and not limitation, show different ways to leverage the dynamic pivot capabilities through the DataFrame API provided by the developer framework 140. The ANY keyword, subqueries, default values, and/or variant output can all be specified to enable flexible pivot table generation. Here are some Python code examples for invoking dynamic pivot through the developer framework:

#Use ANY keyword, for example:
df.pivot(index=[‘Category’], values=[‘Sales’], columns=[‘Product’], aggfunc=‘sum’)

#DataFrame pivot API to trigger dynamic pivot, for example:

df.pivot(pivot_col=[‘product’], values=‘ANY’)
df.pivot(pivot_col=[‘product’], values=‘ANY’, default_on_null=0)

#Specify default on null (e.g., it already has a ‘fill_value’ parameter that uses for the default_on_null value), which is distinguishable from the df.pivot API provided by PANDAS dataframe:

df.pivot(index=[‘Category’], values=[‘Sales’], columns=[‘Product’],
aggfunc=‘sum’, fill_value=0)
)

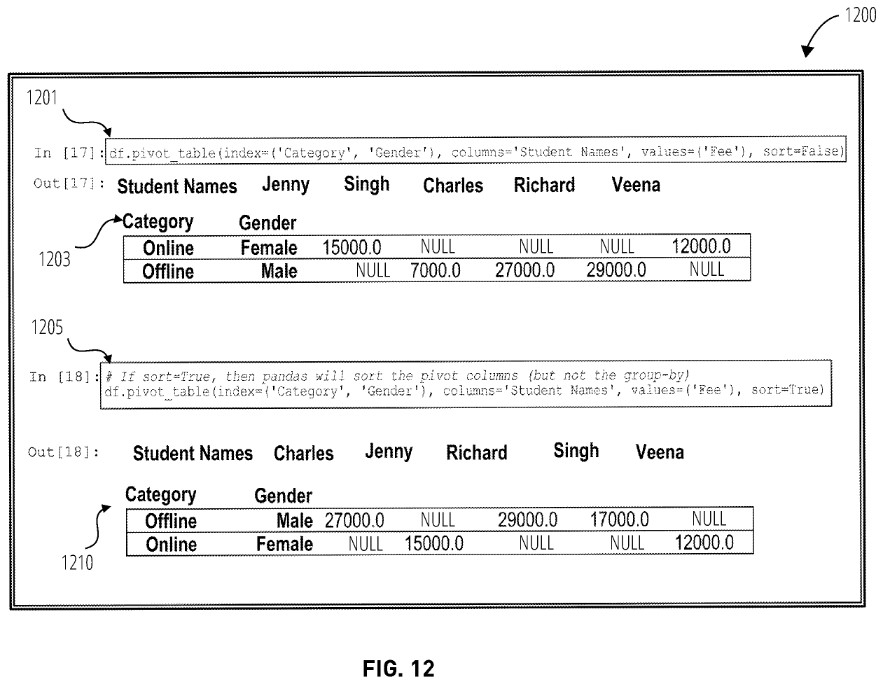

FIG. 12 is a block diagram 1200 illustrating how PANDAS-compatible semantics are employed to perform dynamic pivot ordering, according to example embodiments using dynamic pivoting.

Where the dynamic pivot subquery 1201 with sort=False that does not order the results, and the dynamic pivot subquery 1205 with sort=True that will order both the pivot value columns and the row-wise GROUP-BY column values (not order of GROUP BY columns). The output of the dynamic pivot subquery 1201 is a first DataFrame, such as table 1203, illustrating a pivot table API table without ordering. The output of the dynamic pivot subquery 1205 is a second DataFrame, such as table 1210, illustrating a pivot table API table with ordering.

According to example embodiments, the cloud data platform DataFrame client, such as the SQL engine 142 on the cloud data platform 102 and/or the client environment 116 or the developer framework 140, can wrap the dynamic pivot SQL query to order on the rows by specifying the order by pivot column for the ANY or subquery.

In additional examples, the cloud data platform can provide an option to ORDER BY the metadata column. For example, for ANY, the ORDER BY clause can specify column identifier, position, or expression (e.g., ORDER BY 1,2,3). If the query specifies more than one or an invalid order item, for example, an error can be issued. If the underlying data changes, it is possible that a different set of output columns is produced in the pivot schema. In this case, things like materialized views defined on top of the dynamic pivot would be broken, such as a daily pipeline assuming a fixed schema could be broken. Example embodiments such as FIG. 8B illustrating SQL query 816b with explicit management can provide remedies for such outlier cases.

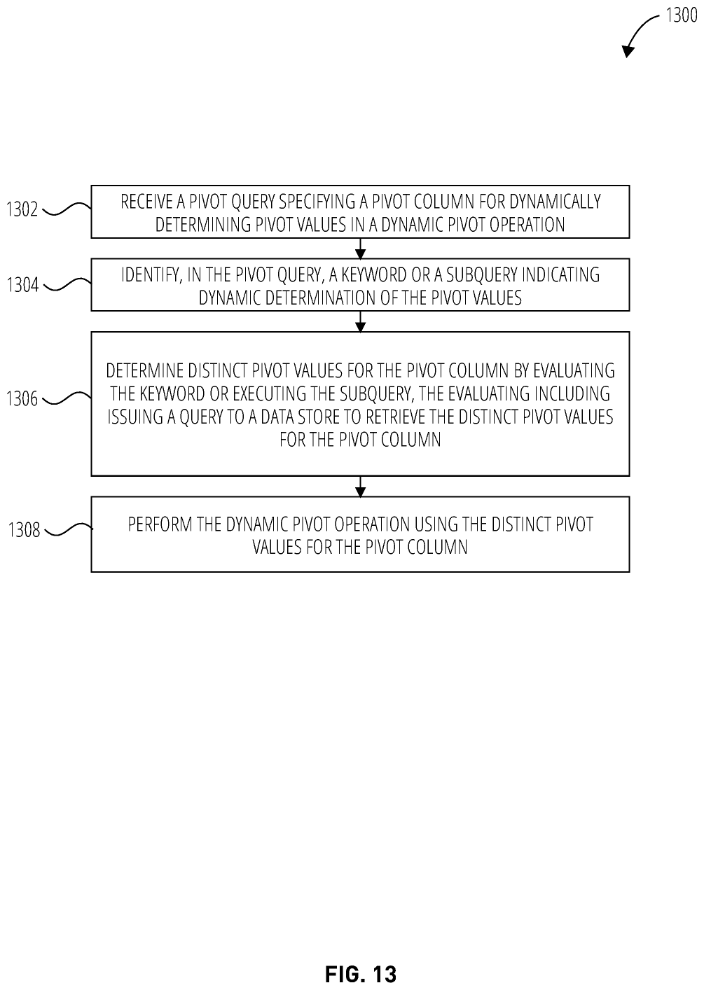

FIG. 13 illustrates an example flow diagram of a method, such as routine 1300, for performing dynamic pivot operations, in accordance with example embodiments. According to the example embodiment of FIG. 13, different examples described herein include methods of performing dynamic pivot operations employing the SQL engine 142 and/or the developer framework 140. For example, the routine 1300 can be embodied in machine-readable instructions or machine storage medium for execution by one or more hardware components such that the operations of the routine 1300 can be performed by components of the cloud data platform 102, the client environment 116, or other components operably interconnected thereto. Accordingly, the routine 1300 is described below, by way of example with reference to components of the cloud data platform 102. However, it shall be appreciated that routine 1300 can be deployed on various other hardware configurations and is not intended to be limited to deployment within the cloud data platform 102. Depending on the embodiment, an operation of the routine 1300 can be repeated in different ways or involve intervening operations not shown. Though the operations of the routine 1300 can be depicted and described in a certain order, the order in which the operations are performed may vary among embodiments, including performing certain operations in parallel or performing sets of operations in separate processes. While the various operations in the routine 1300 are presented and described sequentially, one of ordinary skill will appreciate that some or all of the operations may be executed in a different order, be combined or omitted, or be executed in parallel.

In block 1302, routine 1300 receives a pivot query at the SQL engine 142 specifying a pivot column for dynamically determining pivot values in a dynamic pivot operation. In block 1304, routine 1300 at the SQL engine 142 identifies, in the pivot query, a keyword or a subquery indicating dynamic determination of the pivot values. In block 1306, routine 1300 at the SQL engine 142 determines distinct pivot values for the pivot column by evaluating the keyword or executing the subquery, the evaluating including issuing a query to a data store to retrieve the distinct pivot values for the pivot column, based on identifying the keyword or the subquery indicates the dynamic determination of the pivot values. In block 1308, routine 1300 the SQL engine 142 performs, by at least one hardware processor, the dynamic pivot operation using the distinct pivot values for the pivot column.

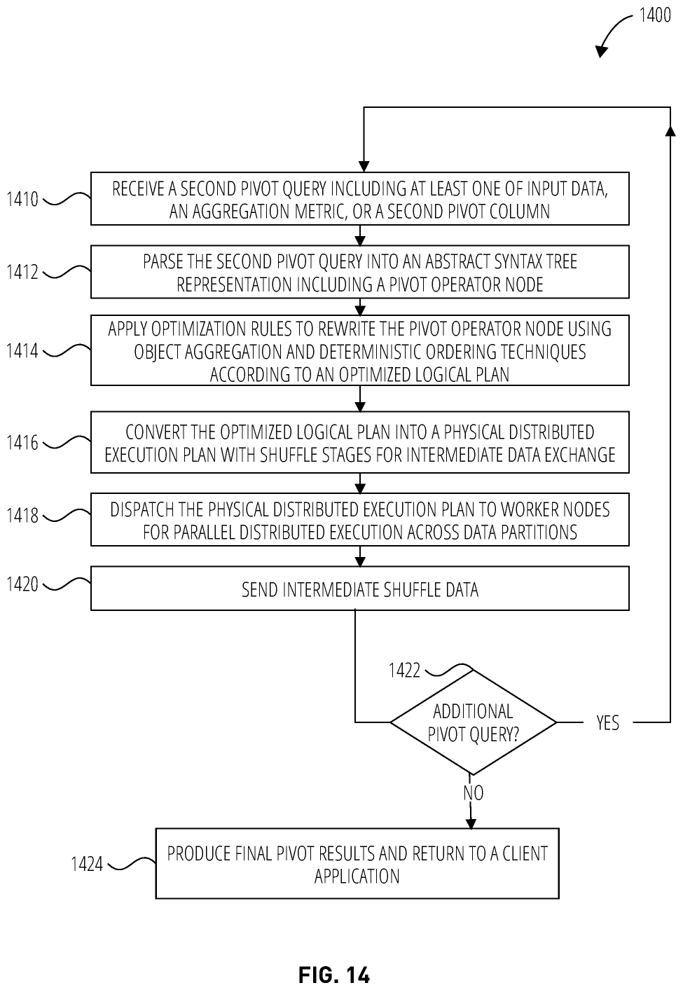

FIG. 14 illustrates an example flow diagram of a method, such as routine 1400, for performing dynamic pivot operations, in accordance with example embodiments.

According to the example embodiment of FIG. 14, different examples described herein include methods of performing dynamic pivot operations employing the SQL engine 142, the server environment 118, the client environment 116, and/or the developer framework 140. For example, the routine 1400 can be embodied in machine-readable instructions or machine storage medium for execution by one or more hardware components such that the operations of the routine 1400 can be performed by components of the cloud data platform 102, the client environment 116, or other components operably interconnected thereto. Accordingly, the routine 1400 is described below, by way of example with reference to components of the cloud data platform 102. However, it shall be appreciated that the routine 1400 can be deployed on various other hardware configurations and is not intended to be limited to deployment within the cloud data platform 102. Depending on the embodiment, an operation of the routine 1400 can be repeated in different ways or involve intervening operations not shown. Though the operations of the routine 1400 can be depicted and described in a certain order, the order in which the operations are performed may vary among embodiments, including performing certain operations in parallel or performing sets of operations in separate processes. While the various operations in the routine 1400 are presented and described sequentially, one of ordinary skill will appreciate that some or all of the operations may be executed in a different order, be combined or omitted, or be executed in parallel.

In block 1410 at the server environment 118, routine 1400 receives a second pivot query including at least one of input data, an aggregation metric, or a second pivot column. In block 1412 at the server environment 118, routine 1400 parses the second pivot query into an abstract syntax tree representation including a pivot operator node. In block 1414, at the server environment 118, routine 1400 applies optimization rules to rewrite the pivot operator node using object aggregation and deterministic ordering techniques according to an optimized logical plan. In block 1416, at the server environment 118, routine 1400 converts the optimized logical plan into a physical distributed execution plan with shuffle stages for intermediate data exchange. In block 1418, at the server environment 118, routine 1400 dispatches the physical distributed execution plan to worker nodes for parallel distributed execution across data partitions. In block 1420, at the server environment 118, routine 1400 streams intermediate shuffle data between the worker nodes via a cluster resource manager.

At block 1422, at the server environment 118, routine 1400 determines if there is another new pivot query to be parsed. If yes, routine 1400 returns to block 1410. If no, routine 1400 continues to block 1424, at the server environment 118, which produces (e.g., materializes, displays, outputs, renders, etc.) final pivot results and returns to a client application.

According to examples of the present disclosure, the data warehouse optimizes pivot queries through query rewriting and distributed execution. The initial pivot query is parsed into an abstract syntax tree where the pivot operator node is identified along with associated input, aggregation, pivot column, and other parameters. Optimization applies rules to simplify expressions, flatten subqueries, and crucially rewrite the pivot node using object aggregation and deterministic ordering techniques. This logical plan is then converted into a physical distributed execution plan by inserting shuffle stages for intermediate data exchange and mapping processing stages to execution locations based on data partitioning. At runtime, the optimized physical plan is dispatched to worker nodes that run assigned fragments against data partitions in parallel, shuffling intermediate data via the cluster resource manager. Massive parallelism is thus achieved. The SQL engine leverages optimization rules and distributed execution to efficiently compute pivot operations at scale beyond the capabilities of traditional single node systems.

Described implementations of the subject matter can include one or more features, alone or in combination as illustrated below by way of example.

Example 1 is a method comprising: receiving a pivot query specifying a pivot column for dynamically determining pivot values in a dynamic pivot operation; identifying, in the pivot query, a keyword or a subquery indicating dynamic determination of the pivot values; based on identifying the keyword or the subquery indicating the dynamic determination of the pivot values, determining distinct pivot values for the pivot column by evaluating the keyword or executing the subquery, the evaluating of the keyword including sending a query to a data store to obtain the distinct pivot values for the pivot column; and performing, by at least one hardware processor, the dynamic pivot operation using the distinct pivot values for the pivot column.

In Example 2, the subject matter of Example 1 includes, wherein performing of the dynamic pivot operation further comprises: sorting output pivot columns based on an order specified in the subquery.

In Example 3, the subject matter of Examples 1-2 includes, wherein the subquery specifies an order for the pivot values.

In Example 4, the subject matter of Examples 1-3 includes, rewriting the pivot query to produce a rewritten pivot query, wherein the rewriting utilizes object aggregation to aggregate data for the pivot column; and executing the rewritten pivot query utilizing the object aggregation to perform the dynamic pivot operation.

In Example 5, the subject matter of Example 4 includes, wherein rewriting the pivot query further comprises: aggregating the data for the pivot column into an object containing a key and a value; extracting the pivot values from the object to generate extracted pivot values; and populating output columns based on the extracted pivot values.

In Example 6, the subject matter of Example 5 includes, wherein utilizing the object aggregation avoids individually aggregating the data for each potential pivot value.

In Example 7, the subject matter of Examples 1-6 includes, wherein receiving the pivot query specifying the pivot column further comprises: receiving the pivot query to pivot a dataset based on values in the pivot column.

In Example 8, the subject matter of Examples 1-7 includes, wherein receiving the pivot query further comprises: receiving a second pivot query including at least one of input data, an aggregation metric, or a second pivot column; parsing the second pivot query into an abstract syntax tree representation including a pivot operator node; and applying optimization rules to rewrite the pivot operator node using object aggregation and deterministic ordering techniques according to an optimized logical plan.

In Example 9, the subject matter of Example 8 includes, converting the optimized logical plan into a physical distributed execution plan with shuffle stages for intermediate data exchange; and dispatching the physical distributed execution plan to worker nodes for parallel distributed execution across data partitions.

In Example 10, the subject matter of Example 9 includes, sending intermediate shuffle data between the worker nodes via a cluster resource manager; and sorting final pivot results; and providing the final pivot results to a client application.

Example 11 is a system comprising: one or more hardware processors of a machine; and at least one memory storing instructions that, when executed by the one or more hardware processors, cause the system to perform operations comprising: receiving a pivot query specifying a pivot column for dynamically determining pivot values in a dynamic pivot operation; identifying, in the pivot query, a keyword or a subquery indicating dynamic determination of the pivot values; based on identifying the keyword or the subquery indicating the dynamic determination of the pivot values, determining distinct pivot values for the pivot column by evaluating the keyword or executing the subquery, the evaluating of the keyword including sending a query to a data store to obtain the distinct pivot values for the pivot column; and performing, by at least one hardware processor, the dynamic pivot operation using the distinct pivot values for the pivot column.

In Example 12, the subject matter of Example 11 includes, wherein performing of the dynamic pivot operation further comprises: sorting output pivot columns based on an order specified in the subquery.

In Example 13, the subject matter of Examples 11-12 includes, wherein the subquery specifies an order for the pivot values.

In Example 14, the subject matter of Examples 11-13 includes the operations comprising: rewriting the pivot query to produce a rewritten pivot query, wherein the rewriting utilizes object aggregation to aggregate data for the pivot column; and executing the rewritten pivot query utilizing the object aggregation to perform the dynamic pivot operation.

In Example 15, the subject matter of Example 14 includes, wherein rewriting the pivot query further comprises: aggregating the data for the pivot column into an object containing a key and a value; extracting the pivot values from the object to generate extracted pivot values; and populating output columns based on the extracted pivot values.

In Example 16, the subject matter of Example 15 includes, wherein utilizing the object aggregation avoids individually aggregating the data for each potential pivot value.

In Example 17, the subject matter of Examples 11-16 includes, wherein receiving the pivot query specifying the pivot column further comprises: receiving the pivot query to pivot a dataset based on values in the pivot column.

In Example 18, the subject matter of Examples 11-17 includes, wherein receiving the pivot query further comprises: receiving a second pivot query including at least one of input data, an aggregation metric, or a second pivot column; parsing the second pivot query into an abstract syntax tree representation including a pivot operator node; and applying optimization rules to rewrite the pivot operator node using object aggregation and deterministic ordering techniques according to an optimized logical plan.

In Example 19, the subject matter of Example 18 includes the operations comprising:
converting the optimized logical plan into a physical distributed execution plan with shuffle stages for intermediate data exchange; and dispatching the physical distributed execution plan to worker nodes for parallel distributed execution across data partitions.

In Example 20, the subject matter of Example 19 includes the operations comprising: sending intermediate shuffle data between the worker nodes via a cluster resource manager; and sorting final pivot results; and providing the final pivot results to a client application.

Example 21 is a machine-storage medium embodying instructions that, when executed by a machine, cause the machine to perform operations comprising: receiving a pivot query specifying a pivot column for dynamically determining pivot values in a dynamic pivot operation; identifying, in the pivot query, a keyword or a subquery indicating dynamic determination of the pivot values; based on identifying the keyword or the subquery indicating the dynamic determination of the pivot values, determining distinct pivot values for the pivot column by evaluating the keyword or executing the subquery, the evaluating of the keyword including sending a query to a data store to obtain the distinct pivot values for the pivot column; and performing, by at least one hardware processor, the dynamic pivot operation using the distinct pivot values for the pivot column.

In Example 22, the subject matter of Example 21 includes, wherein performing of the dynamic pivot operation further comprises: sorting output pivot columns based on an order specified in the subquery.

In Example 23, the subject matter of Examples 21-22 includes, wherein the subquery specifies an order for the pivot values.

In Example 24, the subject matter of Examples 21-23 includes, wherein the operations comprise: rewriting the pivot query to produce a rewritten pivot query, wherein the rewriting utilizes object aggregation to aggregate data for the pivot column; and executing the rewritten pivot query utilizing the object aggregation to perform the dynamic pivot operation.

In Example 25, the subject matter of Example 24 includes, wherein rewriting the pivot query further comprises: aggregating the data for the pivot column into an object containing a key and a value; extracting the pivot values from the object to generate extracted pivot values; and populating output columns based on the extracted pivot values.

In Example 26, the subject matter of Example 25 includes, wherein utilizing the object aggregation avoids individually aggregating the data for each potential pivot value.

In Example 27, the subject matter of Examples 21-26 includes, wherein receiving the pivot query specifying the pivot column further comprises: receiving the pivot query to pivot a dataset based on values in the pivot column.

In Example 28, the subject matter of Examples 21-27 includes, wherein receiving the pivot query further comprises: receiving a second pivot query including at least one of input data, an aggregation metric, or a second pivot column; parsing the second pivot query into an abstract syntax tree representation including a pivot operator node; and applying optimization rules to rewrite the pivot operator node using object aggregation and deterministic ordering techniques according to an optimized logical plan.

In Example 29, the subject matter of Example 28 includes, wherein the operations comprise: converting the optimized logical plan into a physical distributed execution plan with shuffle stages for intermediate data exchange; and dispatching the physical distributed execution plan to worker nodes for parallel distributed execution across data partitions.

In Example 30, the subject matter of Example 29 includes, wherein the operations comprise: sending intermediate shuffle data between the worker nodes via a cluster resource manager; and sorting final pivot results; and providing the final pivot results to a client application.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

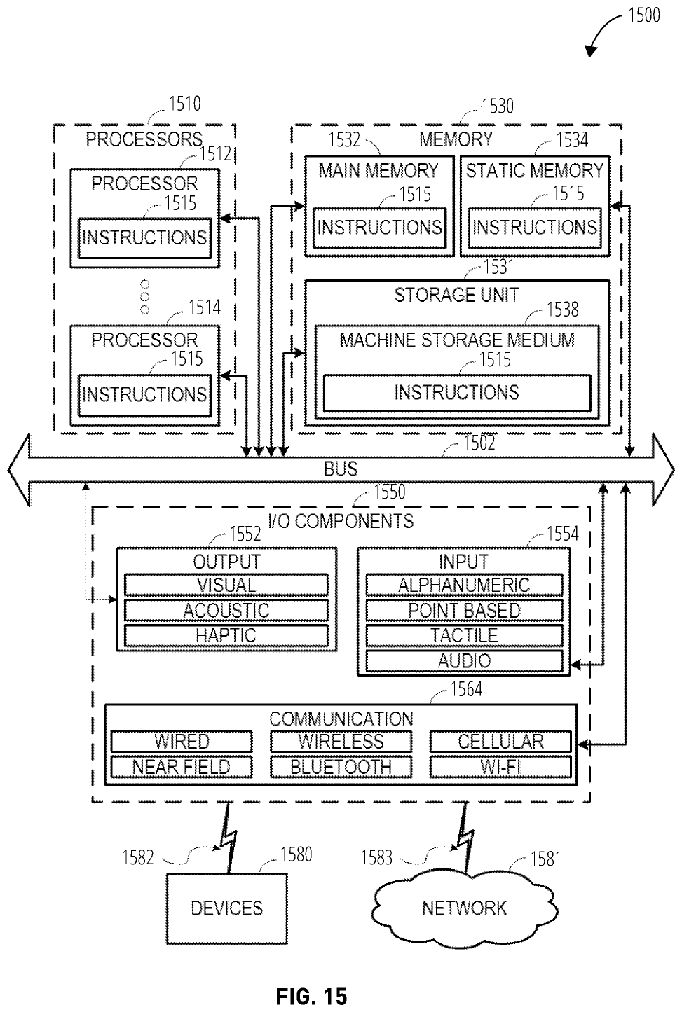

FIG. 15 illustrates a diagrammatic representation of a machine 1500 in the form of a computer system within which a set of instructions may be executed for causing the machine 1500 to perform any one or more of the methodologies discussed herein, according to an example embodiment. Specifically, FIG. 15 shows a diagrammatic representation of the machine 1500 in the example form of a computer system, within which instructions 1515 (e.g., software, a program, an application, an applet, an app, or other executable code), for causing the machine 1500 to perform any one or more of the methodologies discussed herein, may be executed. For example, the instructions 1515 may cause the machine 1500 to implement portions of the data flows described herein. In this way, the instructions 1515 transform a general, non-programmed machine into a particular machine 1500 (e.g., the client device(s) 114 of FIG. 1, the compute service manager 108 of FIG. 1, the execution platform 110 of FIG. 1) that is specially configured to carry out any one of the described and illustrated functions in the manner described herein.

In alternative embodiments, the machine 1500 operates as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1515, sequentially or otherwise, that specify actions to be taken by the machine 1500. Further, while only a single machine 1500 is illustrated, the term “machine” shall also be taken to include a collection of machines 1500 that individually or jointly execute the instructions 1515 to perform any one or more of the methodologies discussed herein.

The machine 1500 includes processors 1510, memory 1530, and input/output (I/O) components 1550 configured to communicate with each other such as via a bus 1502. In an example embodiment, the processors 1510 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1512 and a processor 1514 that may execute the instructions 1515. The term “processor” is intended to include multi-core processors 1510 that may comprise two or more independent processors (sometimes referred to as “cores”) that may execute instructions 1515 contemporaneously. Although FIG. 15 shows multiple processors 1510, the machine 1500 may include a single processor with a single core, a single processor with multiple cores (e.g., a multi-core processor), multiple processors with a single core, multiple processors with multiple cores, or any combination thereof.

The memory 1530 may include a main memory 1532, a static memory 1534, and a storage unit 1531, all accessible to the processors 1510 such as via the bus 1502. The main memory 1532, the static memory 1534, and the storage unit 1531 comprise a machine storage medium 1538 that may store the instructions 1515 embodying any one or more of the methodologies or functions described herein. The instructions 1515 may also reside, completely or partially, within the main memory 1532, within the static memory 1534, within the storage unit 1531, within at least one of the processors 1510 (e.g., within the processor's cache memory), or any suitable combination thereof, during execution thereof by the machine 1500.

The I/O components 1550 include components to receive input, provide output, produce output, transmit information, exchange information, capture measurements, and so on. The specific I/O components 1550 that are included in a particular machine 1500 will depend on the type of machine. For example, portable machines, such as mobile phones, will likely include a touch input device or other such input mechanisms, while a headless server machine will likely not include such a touch input device. It will be appreciated that the I/O components 1550 may include many other components that are not shown in FIG. 15. The I/O components 1550 are grouped according to functionality merely for simplifying the following discussion and the grouping is in no way limiting. In various example embodiments, the I/O components 1550 may include output components 1552 and input components 1554. The output components 1552 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1550 may include communication components 1564 operable to couple the machine 1500 to a network 1581 via a coupler 1583 or to devices 1580 via a coupling 1582. For example, the communication components 1564 may include a network interface component or another suitable device to interface with the network 1581. In further examples, the communication components 1564 may include wired communication components, wireless communication components, cellular communication components, and other communication components to provide communication via other modalities. The devices 1580 may be another machine or any of a wide variety of peripheral devices (e.g., a peripheral device coupled via a universal serial bus (USB)). For example, as noted above, the machine 1500 may correspond to any one of the client device(s) 114, the compute service manager 108, and the execution platform 110, and may include any other of these systems and devices.

The various memories (e.g., 1530, 1532, 1534, and/or memory of the processor(s) 1510 and/or the storage unit 1531) may store one or more sets of instructions 1515 and data structures (e.g., software), embodying or utilized by any one or more of the methodologies or functions described herein. These instructions 1515, when executed by the processor(s) 1510, cause various operations to implement the examples described herein.

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1581 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1581 or a portion of the network 1581 may include a wireless or cellular network, and the coupling 1582 may be a Code Division Multiple Access (CDMA) connection, a Global System for Mobile communications (GSM) connection, or another type of cellular or wireless coupling. In this example, the coupling 1582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1515 may be transmitted or received over the network 1581 using a transmission medium via a network interface device (e.g., a network interface component included in the communication components 1564) and utilizing any one of a number of well-known transfer protocols (e.g., hypertext transfer protocol (HTTP)). Similarly, the instructions 1515 may be transmitted or received using a transmission medium via the coupling 1582 (e.g., a peer-to-peer coupling) to the devices 1580. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1515 for execution by the machine 1500, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the examples described herein is to be determined with reference to the appended claims, along with the full scope of equivalents to which such claims are entitled.

1. A method comprising:
receiving a pivot query specifying a pivot column for dynamically determining a pivot value in a dynamic pivot operation, the dynamic pivot operation comprising specifying a distinct pivot value dynamically at runtime;
identifying, in the pivot query, a subquery indicating dynamic determination of the pivot value;
based on identifying the subquery indicating the dynamic determination of the pivot value, specifying the distinct pivot value for the pivot column at the runtime by executing the subquery, the executing of the subquery comprising transmitting a query to a data store to obtain the distinct pivot value for the pivot column; and
performing, by at least one hardware processor, the dynamic pivot operation using the distinct pivot value for the pivot column.

2. The method of claim 1, wherein performing of the dynamic pivot operation further comprises:
sorting output pivot columns based on an order specified in the subquery.

3. The method of claim 1, wherein the subquery specifies an order for the pivot value.

4. The method of claim 1, further comprising:
rewriting the pivot query to produce a rewritten pivot query, wherein the rewriting utilizes object aggregation to aggregate data for the pivot column; and
executing the rewritten pivot query utilizing the object aggregation to perform the dynamic pivot operation.

5. The method of claim 4, wherein rewriting the pivot query further comprises:
aggregating the data for the pivot column into an object containing a key and a value;
extracting the pivot value from the object to generate extracted pivot value; and
populating output columns based on the extracted pivot value.

6. The method of claim 5, wherein utilizing the object aggregation avoids individually aggregating the data for each potential pivot value.

7. The method of claim 1, wherein receiving the pivot query specifying the pivot column further comprises:
receiving the pivot query to pivot a dataset based on values in the pivot column.

8. The method of claim 1, wherein receiving the pivot query further comprises:
receiving a second pivot query including at least one of input data, an aggregation metric, or a second pivot column;
parsing the second pivot query into an abstract syntax tree representation including a pivot operator node; and
applying optimization rules to rewrite the pivot operator node using object aggregation and deterministic ordering techniques according to an optimized logical plan.

9. The method of claim 8, further comprising:
converting the optimized logical plan into a physical distributed execution plan with shuffle stages for intermediate data exchange; and
dispatching the physical distributed execution plan to worker nodes for parallel distributed execution across data partitions.

10. The method of claim 9, further comprising:
sending intermediate shuffle data between the worker nodes via a cluster resource manager;
sorting final pivot results; and
providing the final pivot results to a client application.

11. A system comprising:
one or more hardware processors of a machine; and
at least one memory storing instructions that, when executed by the one or more hardware processors, cause the system to perform operations comprising:
receiving a pivot query specifying a pivot column for dynamically determining a pivot value in a dynamic pivot operation, the dynamic pivot operation comprising specifying a distinct pivot value dynamically at runtime;
identifying, in the pivot query, a subquery indicating dynamic determination of the pivot value;
based on identifying the subquery indicating the dynamic determination of the pivot value, specifying the distinct pivot value for the pivot column at the runtime by executing the subquery, the executing of the subquery comprising transmitting a query to a data store to obtain the distinct pivot value for the pivot column; and
performing the dynamic pivot operation using the distinct pivot value for the pivot column.

12. The system of claim 11, wherein performing of the dynamic pivot operation further comprises:
sorting output pivot columns based on an order specified in the subquery.

13. The system of claim 11, wherein the subquery specifies an order for the pivot value.

14. The system of claim 11, the operations comprising:
rewriting the pivot query to produce a rewritten pivot query, wherein the rewriting utilizes object aggregation to aggregate data for the pivot column; and
executing the rewritten pivot query utilizing the object aggregation to perform the dynamic pivot operation.

15. The system of claim 14, wherein rewriting the pivot query further comprises:
aggregating the data for the pivot column into an object containing a key and a value;
extracting the pivot value from the object to generate extracted pivot value; and
populating output columns based on the extracted pivot value.

16. The system of claim 15, wherein utilizing the object aggregation avoids individually aggregating the data for each potential pivot value.

17. The system of claim 11, wherein receiving the pivot query specifying the pivot column further comprises:
receiving the pivot query to pivot a dataset based on values in the pivot column.

18. The system of claim 11, wherein receiving the pivot query further comprises:
receiving a second pivot query including at least one of input data, an aggregation metric, or a second pivot column;
parsing the second pivot query into an abstract syntax tree representation including a pivot operator node; and
applying optimization rules to rewrite the pivot operator node using object aggregation and deterministic ordering techniques according to an optimized logical plan.

19. The system of claim 18, the operations comprising:
converting the optimized logical plan into a physical distributed execution plan with shuffle stages for intermediate data exchange; and
dispatching the physical distributed execution plan to worker nodes for parallel distributed execution across data partitions.

20. The system of claim 19, the operations comprising:
sending intermediate shuffle data between the worker nodes via a cluster resource manager;
sorting final pivot results; and
providing the final pivot results to a client application.

21. A machine-storage medium embodying instructions that, when executed by a machine, cause the machine to perform operations comprising:
receiving a pivot query specifying a pivot column for dynamically determining a pivot value in a dynamic pivot operation, the dynamic pivot operation comprising specifying a distinct pivot value dynamically at runtime;
identifying, in the pivot query, a subquery indicating dynamic determination of the pivot value;
based on identifying the subquery indicating the dynamic determination of the pivot value, specifying the distinct pivot value for the pivot column at the runtime by executing the subquery, the executing of the subquery comprising transmitting a query to a data store to obtain the distinct pivot value for the pivot column; and
performing the dynamic pivot operation using the distinct pivot value for the pivot column.

22. The machine-storage medium of claim 21, wherein performing of the dynamic pivot operation further comprises:
sorting output pivot columns based on an order specified in the subquery.

23. The machine-storage medium of claim 21, wherein the subquery specifies an order for the pivot value.

24. The machine-storage medium of claim 21, wherein the operations comprise:
rewriting the pivot query to produce a rewritten pivot query, wherein the rewriting utilizes object aggregation to aggregate data for the pivot column; and
executing the rewritten pivot query utilizing the object aggregation to perform the dynamic pivot operation.

25. The machine-storage medium of claim 24, wherein rewriting the pivot query further comprises:
aggregating the data for the pivot column into an object containing a key and a value;
extracting the pivot value from the object to generate extracted pivot value; and
populating output columns based on the extracted pivot value.

26. The machine-storage medium of claim 25, wherein utilizing the object aggregation avoids individually aggregating the data for each potential pivot value.

27. The machine-storage medium of claim 21, wherein receiving the pivot query specifying the pivot column further comprises:
receiving the pivot query to pivot a dataset based on values in the pivot column.

28. The machine-storage medium of claim 21, wherein receiving the pivot query further comprises:
receiving a second pivot query including at least one of input data, an aggregation metric, or a second pivot column;
parsing the second pivot query into an abstract syntax tree representation including a pivot operator node; and
applying optimization rules to rewrite the pivot operator node using object aggregation and deterministic ordering techniques according to an optimized logical plan.

29. The machine-storage medium of claim 28, wherein the operations comprise:
converting the optimized logical plan into a physical distributed execution plan with shuffle stages for intermediate data exchange; and
dispatching the physical distributed execution plan to worker nodes for parallel distributed execution across data partitions.

30. The machine-storage medium of claim 29, wherein the operations comprise:
sending intermediate shuffle data between the worker nodes via a cluster resource manager;
sorting final pivot results; and
providing the final pivot results to a client application.
